(19) United States
(12) Patent Application Publication
(10) Pub. No.: US 2016/0257772 A1
(43) Pub. Date: Sep. 8, 2016

(54) CATALYSTS AND METHODS OF CONTROLLING LONG CHAIN BRANCHING IN POLYOLEFINS

(71) Applicant: EQUISTAR CHEMICALS, LP, Houston, TX (US)

(72) Inventors: MICHAEL W LYNCH, West Chester, OH (US); Mark K. Reinking, Mason, OH (US)

(73) Assignee: EQUISTAR CHEMICALS, LP, Houston, TX (US)

(21) Appl. No.: 15/058,375

(22) Filed: Mar. 2, 2016

Related U.S. Application Data
(60) Provisional application No. 62/126,788, filed on Mar. 2, 2015.

(51) Int. Cl. C08F 10/02; B01J 37/08; B01J 37/04; B01J 23/26; B01J 35/10

(52) U.S. Cl. CPC C08F 10/02; B01J 23/26; B01J 35/1019; B01J 35/1023; B01J 35/1042; B01J 35/1047; B01J 37/04; B01J 37/08

(57) ABSTRACT

The present disclosure relates to catalysts comprising two heterogeneous chromium catalysts for the polymerization of olefins are provided herein. The catalysts, as well as related compositions and methods using the same, may be used to for the production of polyolefins, including for the production of bimodal molecular weight distribution polyolefins, e.g., polyethylene and copolymers of ethylene and 1-hexene.

### CROSS-REFERENCE TO RELATED APPLICATIONS

This application claims the benefit and priority of U.S. Provisional Application No. 62/126,788, filed Mar. 2, 2015, the content of which is incorporated herein by reference in its entirety.

### FIELD OF THE INVENTION

The present disclosure relates to chemistry. In some embodiments, the present disclosure relates to catalysts, catalyst compositions, and methods for the polymerization of olefins.

### BACKGROUND OF THE INVENTION

Chromium(Cr)/silica catalysts may be used to produce a broad molecular weight distribution (MWD) polyolefin-based polymers, for example, in single slurry loop or single gas phase reactors. Such polymers are suitable for many applications. The ability to introduce long chain branching (LCB) into the polymer has further extended the versatility of these polymers. One commercial application for polymers produced from Cr/silica catalysts includes resins for blow molding with good swell characteristics and blown film resins that exhibit good bubble stability during film fabrication. Bimodal molecular weight distribution polymers are useful for application demanding properties such as environmental stress crack resistance (ESCR) and drop impact strength. However, bimodal blow molding resins are prepared using multiple polymerization catalysts in multiple different reactors. Furthermore, control over the amount and location of long chain branching and co-monomer incorporation within the polymer is difficult. Control of these properties is useful for modifying stiffness/toughness and processability. Developing catalysts and methods to prepare polymers therefore remains a goal of polyolefin polymerization.

### SUMMARY OF THE INVENTION

In one aspect, the present disclosure provides for a composition comprising:
(A) a first catalyst comprising from about 0.25 wt. % to about 2 wt. % chromium deposited on a first solid oxide component, wherein the first catalyst has a pore volume from about 1.0 mL/g to about 3.5 mL/g and a surface area from about 250 m²/g to about 900 m²/g; and
(B) a second catalyst comprising from about 0.25 wt. % to about 2 wt. % chromium deposited on a second solid oxide component, wherein the second catalyst has a pore volume from about 1.0 mL/g to about 2.5 mL solid /g and a surface area from about 400 m²/g to about 1000 m²/g;
   wherein the first and second catalysts are present at a weight ratio from 1:9 to 9:1, provided that the first catalyst and second catalyst are not the same.

In some embodiments, the first catalyst further comprises from about 0.5 wt. % to about 5.0 wt. % titanium or aluminum. In some embodiments, the first catalyst has a surface area from about 250 m²/g to about 600 m²/g. In some embodiments, the first catalyst has a pore volume from about 1.0 mL/g to about 2.5 mL/g.

In some embodiments, the second catalyst further comprises from about 0.5 wt. % to about 5 wt. % aluminum, titanium, or zirconium or from about 0.1 wt. % to about 1 wt. % boron or fluorine. In some embodiments, the second catalyst has a surface area from about 500 m²/g to about 1000 m²/g.

In some embodiments, the first solid oxide component and the second solid oxide component may consist essentially of silica.

In yet another aspect, the present disclosure provides for a method comprising:
(A) obtaining a first catalyst, wherein:
   the first catalyst comprises from about 0.25 wt. % to about 2 wt. % chromium deposited on a first solid oxide component, wherein the first catalyst has a pore volume from about 1.0 mL/g to about 3.5 mL/g and a surface area from about 250 m²/g to about 900 m²/g;
(B) heating the first catalyst to a temperature from about 700° C. to about 900° C. to form an activated first catalyst;
(C) obtaining a second catalyst, wherein:
   the second catalyst comprises from about 0.25 wt. % to about 2 wt. % chromium deposited on a second solid oxide component, wherein the second catalyst has a pore volume from about 1.0 mL/g to about 2.5 mL/g and a surface area from about 400 m²/g to about 1000 m²/g; and either one of steps (D) and (E):
(D) heating the second catalyst to a temperature from about 400° C. to about 700° C. to form an activated second catalyst and then admixing the activated second catalyst to the first activated first catalyst; or
(E) admixing the second catalyst to the activated first catalyst and heating this catalyst mixture to a temperature from about 400° C. to about 700° C. to further activate this catalyst mixture;
   wherein the first and second activated catalysts are present in a weight ratio from 1:9 to 9:1, provided that the first activated catalyst and second activated catalyst are not the same. In some embodiments, the first catalyst and second catalyst are heated in the presence of air.

In still another aspect, the present disclosure provides for a method comprising:
(A) admixing a monomer, wherein the monomer is an olefin(_{c}<₆), and the composition of claim 1 to form a reaction mixture; and
(B) reacting the monomer in the presence of the composition under conditions sufficient to form a polyolefin with a bimodal molecular weight distribution.

In some embodiments, the monomer is ethylene and the polyolefin is polyethylene. In some embodiments, the first mode of the molecular weight distribution of the polyolefin is a low molecular weight mode from 80,000 Dalton to 130,000 Daltons and wherein the second mode of the molecular weight distribution of the polyolefin is a high molecular weight mode from about 84,000 Daltons to 300,000 Daltons, provided that the average molecular weight of the second mode is greater than the first mode. In some embodiments, the amount of the monomer in the reaction mixture is from about 0.1 mol. % to about 15 mol. %, based upon the total soluble components present in the reaction mixture.

In some embodiments, the method further comprises adding a comonomer to the reaction mixture, wherein the comonomer is an olefin(_{c<12}). In some embodiments, the comonomer is 1-hexene.

In some embodiments, the high molecular weight mode of the polyolefin has a lower extent of long chain branching relative to the low molecular weight mode of the polyolefin, as measured by the long chain branching index. In some embodiments, the high molecular weight mode of the polyolefin contains more of the incorporated comonomer relative to the low molecular weight mode of the polyolefin, as measured by short chain branching index. In some embodiments, the high molecular weight mode of the polyolefin has a lower extent of long chain branching relative to the low molecular weight mode of the polyolefin, as measured by the long chain branching index.

In some embodiments, the method further comprises adding at least one of the following to the reaction mixture:
(a) a co-catalyst selected from the group consisting of trialkylboron_{(C≦24)}, trialkylaluminum_{(C≦24)}, dialkylzinc_{(C≦18)}, and alkyllithium_{(C≦12)};
(b) hydrogen gas; or
(c) both (a) and (b); and
   followed by heating the reaction mixture to a temperature from about 75° C. to about 120° C. In some embodiments, the trialkylboron(_{c<12}) is triethylboron.

While multiple embodiments are disclosed, still other embodiments will become apparent to those skilled in the art from the following detailed description. As will be apparent, certain embodiments, as disclosed herein, are capable of modifications in various aspects, all without departing from the spirit and scope of the claims as presented herein. Accordingly, the drawings and detailed description are to be regarded as illustrative in nature and not restrictive.

### BRIEF DESCRIPTION OF THE DRAWINGS

The following figures illustrate various embodiments of the subject matter disclosed herein. The claimed subject matter may be understood by reference to the following description taken in conjunction with the accompanying figures, in which like reference numerals identify like elements, and in which:

FIG. 1A shows the log M_{w} as a function of co-monomer incorporation and percentage of the polymer when using Example 1 as a catalyst.

FIG. 1B shows the log M_{w} as a function of co-monomer incorporation and percentage of the polymer when using Example 2 as a catalyst.

FIG. 1C shows the log M_{w} as a function of co-monomer incorporation and percentage of the polymer when using Example 3 as a catalyst.

FIG. 1D shows the log M_{w} as a function of co-monomer incorporation and percentage of the polymer when using Example 4 as a catalyst.

FIG. 1E shows the log M_{w} as a function of co-monomer incorporation and percentage of the polymer when using Example 5 as a catalyst.

FIG. 1F shows the log M_{w} as a function of co-monomer incorporation and percentage of the polymer when using Example 6 as a catalyst.

FIG. 1G shows the log M_{w} as a function of co-monomer incorporation and percentage of the polymer when using Example 7 as a catalyst.

FIG. 1H shows the log M_{w} as a function of co-monomer incorporation and percentage of the polymer when using Example 8 as a catalyst.

FIG. 2 shows the long chain branching as a function of the high load melt index for a variety of catalysts both in the absence and presence of a co-catalyst such as a trialkylboron.

FIG. 3 shows the long chain branching as a function of the high load melt index for catalysts which show a tendency to produce polymers with a high load melt index both in the absence and presence of a co-catalyst such as a trialkylboron.

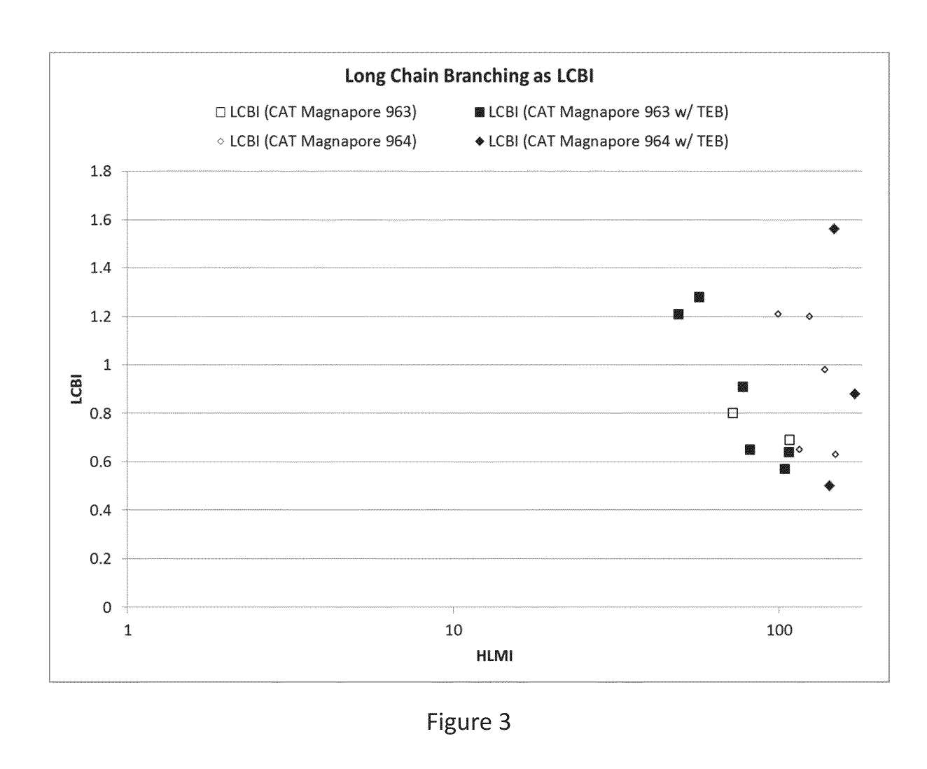

FIG. 4 shows the change of the log of the weight per log of melt index as a function of the molecular weight.

FIG. 5A shows the change of viscosity as a function of frequency.

FIG. 5B shows the van Gurp-Palmen plot showing the change of phase angle as a function of G*.

FIG. 5C shows the Arnett plot showing the log of zero shear viscosity as a function of the log of the molecular weight.

FIG. 6A shows the mileage of each of the CAT 121 and CAT 123 as a function of triethylboron and hydrogen gas pressure.

FIG. 6B shows the high impact melt index of each of the CAT 121 and CAT 123 as a function of triethylboron and hydrogen gas pressure.

FIG. 7A shows the change of the log of the weight per log of melt index as a function of the molecular weight.

FIG. 7B shows the change of viscosity as a function of frequency.

FIG. 7C shows the van Gurp-Palmen plot showing the change of phase angle as a function of G*.

FIG. 7D shows the Arnett plot showing the log of zero shear viscosity as a function of the log of the molecular weight.

### DETAILED DESCRIPTION

In some aspects, the present disclosure relates to a composition of two or more chromium catalysts which allows control of the distribution of the long chain branching and the incorporation of a co-monomer within specific portions of the molecular weight distribution. In some embodiments, the composition comprises two chromium catalysts wherein one of the chromium catalysts incorporates more of the co-monomer in one portion of the molecular weight distribution and increases the long chain branching in the same or the other portion of the molecular weight distribution. In another aspect, the present disclosure also provides methods of using the catalyst composition to obtain a polymer with control over the long chain branching and the incorporation of a co-monomer.

### Cr/Silica Polymerization Catalysts

In some aspects, the present disclosure provides for a composition of two or more catalysts wherein each of the catalysts has a different composition. In some embodiments, the composition comprises a first chromium catalyst and a second chromium catalyst. In some aspects of the present disclosure, the composition comprises a ratio of about 9:1 to about 1:9 of the first catalyst to the second catalyst. In some embodiments, the ratio is from about 7:3 to about 3:7. In some embodiments, the ratio is about 6:4, 1:1, or 4:6.

### II. First Catalyst Composition

In some aspects of the present disclosure, the composition comprises a first catalyst which has a silica solid component and from about 0.25 wt. % to about 2 wt. % chromium. The addition of chromium to a silica solid component is described by U.S. Pat. Nos. 3,976,632 and 4,297,460. In some embodiments, the first catalyst further comprises one or more additional metals on the solid component. In some embodiments, the one or more additional metals are selected from aluminum and titanium. When the first catalyst comprises titanium, the first catalyst may comprise from about 0.5 wt. % to about 5 wt. % titanium. When the first catalyst comprises aluminum, the first catalyst may comprise from about 0.5 wt. % to about 5 wt. % aluminum.

In some embodiments, the solid component of the first catalyst is a silica solid component wherein the solid component has a specific pore volume or specific surface area. The solid component of the first catalyst may have a pore volume from about 1.0 mL/g to about 3.5 mL/g. In some embodiments, the solid component of the first catalyst may have a pore volume from about 1.75 mL/g to about 3.0 mL/g. In some embodiments, the solid component of the first catalyst may have a pore volume from about 2.0 mL/g to about 2.5 mL/g. The solid component of the first catalyst may have a surface area from about 250 m²/g to about 900 m²/g. In some embodiments, the surface area may be from about 250 m²/g to about 750 m²/g. In some embodiments, the surface area may be from about 300 m²/g to about 600 m²/g.

In some aspects of the present disclosure, the methods and processes as provided herein may include the step of activating the first catalyst at an elevated temperature. In some embodiments, the first catalyst may be activated at a temperature from about 700° C. to about 900° C. The process of activating the first catalyst may further include the step of increasing the temperature at a rate from about 0.5° C./min to about 3.0° C./min. In some embodiments, the temperature is increased at a rate from about 1.0° C./min to about 2.0° C./min. In some embodiments, the first catalyst may be activated at a temperature for a time period from more than about 10 seconds to about 60 hours. In some embodiments, the time period for activating the catalyst may range from about 1 hour to about 12 hours. In some embodiments, the time period for activating the catalyst may range from about 3 hours to about 8 hours. The process for activating the first catalyst may further include the step of heating the first catalyst composition under an inert environment (e.g., in the absence of a reactive gaseous material with respect to the catalyst). In some embodiments, the inert environment is nitrogen. In other embodiments, the activation of the first catalyst further comprises heating under air. In other embodiments, the first catalyst can be activated as described in the methods taught in U.S. Pat. No. 4,041,224. In some aspects, the activation process comprises the steps of heating to a first temperature from about 100° C. to about 200° C. for a first time period from about 1 hour to about 8 hours under an inert environment, following by heating the catalyst to a second temperature from about 700° C. to about 900° C. for a second time period from about 3 hours to about 12 hours under an inert environment wherein the environment is changed from an inert environment to air at an intermediate temperature from about 400° C. to about 600° C.

In some aspects, the activation process further comprises a cool down period wherein the temperature is decreased to about room temperature at a rate of temperature change from about 0.5° C./min to about 2.0° C./min and wherein the environment is changed from air to an inert environment at a second intermediate temperature from about 250° C. to about 400° C. In one non-limiting example, the first catalyst is activated by heating to a first temperature of about 150° C. for about 4 hours under an inert environment, followed by heating to a second temperature from about 700° C. to about 900° C. for about 6 hours under air wherein the environment is changed from an inert environment to air at an intermediate temperature of about 540° C., and finally, the first catalyst is cooled to about room temperature (about 25° C.) under an inert environment wherein the environment is changed from air to an inert environment at a second intermediate temperature of about 315° C.

### III. Second Catalyst Composition

In some aspects, the composition further comprises a second catalyst wherein the second catalyst comprises a silica solid component and wherein the second catalyst comprises about 0.25 wt. % to about 2.0 wt. % chromium. In some embodiments, the second catalyst further comprises one or more additional metals. The additional metals may include, but are not limited to aluminum, titanium, zirconium, and/or boron. In some embodiments, the second catalyst comprises: (i) from about 0.5 wt. % to about 2.0 wt. % of aluminum, titanium, and/or zirconium. and/or (ii) from about 0.1 wt. % to about 1.0 wt. % of boron and/or fluoride. The second catalyst comprises a silica solid component that may have a specific pore volume and a specific surface area. The pore volume of the silica solid component may range from about 1.0 mL/g to about 2.5 mL/g. In some embodiments, the pore volume may be from about 1.0 mL/g to about 2.0 mL/g. In a specific embodiment, the pore volume is about 1.4 mL/g. In some aspects, the silica solid component of the second catalyst may have a surface area from about 250 m²/g to about 1,000 m²/g. In some embodiments, the silica solid component may have a surface area from about 350 m²/g to about 900 m²/g.

In some aspects of the present disclosure, the process for activating the second catalyst may include the step of activating the second catalyst at a temperature from about 400° C. to about 700° C. The process for activating the second catalyst may further include the step of increasing the temperature at a rate from about 0.5° C./min to about 2.0° C./min. In some embodiments, the temperature is increased at a rate of about 1.0° C./min. In some embodiments, the second catalyst may be activated at a temperature for a time period from more than about 10 minutes to about 60 hours. In some embodiments, the time period for activating the catalyst may range from about 1 hour to about 12 hours. In some embodiments, the time period for activating the catalyst may range from about 3 hours to about 8 hours.

In some embodiments, the activation of the second catalyst may further comprise the step of heating the second catalyst composition under an inert environment (e.g., in the absence of a reactive gaseous material with respect to the catalyst). In some embodiments, the inert environment is nitrogen. In other embodiments, the activation of the second catalyst further comprises heating under air. In other embodiments, the first catalyst can be activated as described in U.S. Pat. No. 4,041,224. In some aspects, the activation process comprises the steps of heating to a first temperature from about 100° C. to about 200° C. for a first time period from about 1 hour to about 8 hours under an inert environment, following by heating the catalyst to a second temperature from about 400° C. to about 700° C. for a second time period from about 3 hours to about 12 hours under an inert environment wherein the environment is changed from an inert environment to air at the second temperature.

In some aspects, the activation process further comprises a cool down period wherein the temperature is decreased to about room temperature at a rate of temperature change from about 0.5° C./min to about 2.0° C./min and wherein the environment is changed from air to an inert environment at a second intermediate temperature from about 250° C. to about 400° C. In one non-limiting example, the second catalyst is activated by heating to a first temperature of about 150° C. for about 4 hours under an inert environment, followed by heating to a second temperature from about 400° C. to about 700° C. for about 6 hours under air wherein the environment is changed from an inert environment to air at an intermediate temperature of about 540° C., and finally, the first catalyst is cooled to about room temperature under an inert environment wherein the environment is changed from air to an inert environment at a second intermediate temperature of about 315° C.

### IV. Characteristics of Polyolefin

In some aspects of the present disclosure, a polymer comprised of olefin(_{c}<₁₂) monomers is described herein. In some embodiments, the polymer is a polyethylene formed by the polymerization of ethylene. In some embodiments, the polymer comprises one or more comonomer(s) selected from an olefin_{(C≦12)} or a substituted olefin_{(C≦12)}. Some non-limiting examples of the comonomer(s) include 1-butene, 1-hexene, or 1-octene. In some aspects, the polymer of the present disclosure includes a bimodal or pseudo-bimodal distribution of molecular weights. In some embodiments, the bimodal distribution comprises a low melt index component and a high melt index component. The bimodal distribution may also be described according to a low molecular weight fraction or component and a high molecular weight fraction or component.

In some aspects of the present disclosure, the polymer composition of the high melt index or the low molecular weight fraction or component has a long chain branching index (LCBI) of greater than 0.6. In some embodiments, the LCBI of the high melt index component is greater than the LCBI of the low melt index component. Additionally, the short chain branching distribution (SCBD) of the high melt index component is less than the low melt index wherein the SCBD is measured by gel permeation chromatography infrared spectroscopy (GPC IR). The amount of co-monomer incorporated, is gauged, for example, by the percent of co-monomer in the polymer or mode of the bimodal distribution with a molecular weight of greater than 300,000 Daltons. In one embodiment, the high melt index component comprises less of the co-monomer than the low melt index component. In some aspects, the bimodal distribution of molecular weights of the polymer comprises a high melt index component wherein the component has a polymer molecular weight (M_{w}) from about 30,000 Daltons to about 350,000 Daltons and the high melt index component has a lower M_{w} than the low melt index component. In some embodiments, the polymer molecular weight is from about 40,000 Daltons to about 250,000 Daltons, including from about 50,000 Daltons to about 150,000 Daltons. Additionally, in some embodiments the M_{w}/Mₙ of the high melt index component is about 8 to about 15. In certain embodiments, the MI₂ of the high melt index component is from about 0.1 to about 10 while the MI_{21.6} is from about 5 to about 200, wherein the MI₂ and MI_{21.6} of the high melt index component is greater than the MI₂ or MI_{21.6} of the low melt index component. In some aspects, the high melt index component is gel free.

In some aspects, the low melt index component or the high molecular weight fraction has a polymer molecular weight (M_{w}) from about 75,000 Daltons to about 600,000 Daltons or wherein the M_{w}/Mₙ is from about 8 to 15. In some embodiments, the polymer molecular weight is from about 80,000 Daltons to about 500,000 Daltons, including from about 100,000 Daltons to about 400,000 Daltons. In some embodiments, the long chain branching is less than 0.8. In some embodiments, the long chain branching is less than the low molecular weight fraction. In some embodiments, the low melt index component has a MI₂ of less than 1 and a MI_{21.6} of less than 50. In some embodiments, the melt index is lower than the melt index in the low molecular weight fraction. In addition, the bimodal molecular weight distribution comprises from about 10% to about 90% of the high melt index and from about 10% to about 90% of the low melt index. In some aspects, the low melt index component is gel free.

In another aspect, the final polyolefin has a bimodal distribution of molecular weights. In some embodiments, the bimodal distribution has a M_{w} from about 50,000 Daltons to about 600,000 Daltons. In some embodiments, the final polyolefin may have a molecular weight from about 75,000 Daltons to about 500,000 Daltons. In some embodiments, the molecular weight may be from about 100,000 Daltons to about 400,000 Daltons, from about 110,000 Daltons to about 350,000 Daltons, or from about 130,000 Daltons to about 250,000 Daltons. In some embodiments, the final polyolefin composition has a LCBI from about 0.1 to about 1, or from about 0.2 to 0.9.

In some embodiments, the final polyolefin may have a polydispersity index (PI) (M_{w}/Mₙ) from about 10 to about 30. In some embodiments, the final polyolefin may have a polydispersity index from about 13 to 27, including from about 15 to 25.

In some embodiments, the MI₂ and MI_{21.6} of the final polyolefin composition may be less than the MI₂ and MI_{21.6} of the low melt index component.

In some embodiments, the final polyolefin composition may have a MI₂ from 0.01 to 3 g/10 min. The final polyolefin composition may have a MI₂ from 0.05 to 1 g/10 min. In some embodiments, the final polyolefin composition may have a high load melt index from 1 to 150 g/10 min. The final polyolefin composition may have a high load melt index from 3 to 50 g/10 min, including from 5 to 40 g/10 min. In some embodiments, the final polyolefin composition may have a melt index ratio (MIR), as defined below, ranging from 50 to 200, including from 70 to 150 or from 90 to 130. In some aspects, the final polyolefin composition is gel free.

### V. Polyolefin Polymerization

In some aspects, the present disclosure provides for one or more methods of using a catalyst composition of the present disclosure to polymerize an olefin_{(C≦6)} to produce a polyolefin. In some embodiments, the olefin is ethylene and the resultant polyolefin is polyethylene. In some embodiments, the polymerization reaction further comprises one or more olefinic co-monomers. In some embodiments, the olefinic co-monomers include an olefin_{(C≦12)}. In some embodiments, the olefinic co-monomer is butene, hexene, or octene. In some embodiments, the polymerization reaction mixture comprises from about 5 mol. % to about 15 mol. % of monomeric and/or co-monomeric units, based upon the total weight of components in the reaction mixture, with the balance of the reaction mixture comprising catalyst, co-catalyst, and additional components as described herein. In further embodiments, the polymerization reaction comprises heating the reaction to a temperature from about 50° C. to about 125° C. Additionally, the polymerization reaction, in some embodiments, further comprises using hydrogen in the reaction. The polymerization reaction, in some embodiments, comprises using from about 0 psi to about 500 psi (0 MPa to about 3.44 MPa) of hydrogen gas wherein the pressure is measured as a change in pressure from the addition vessel. Co-catalyst compounds containing boron, lithium, zinc, or aluminum may be used in the polymerization to further modify the first catalyst or the second catalyst. The modifiers may be included to increase activity, improve operability, or enhance the processability or physical properties of the polymer. Examples include borate esters, trialkyboranes, triarylboranes, aluminum alkoxides, alkylaluminum compounds, or alkylzinc compounds, and the like, and mixtures thereof. Additional non-limiting examples of suitable modifiers are disclosed in U.S. Pat. Nos. 2,825,721; 3,780,011; 4,173,548; 4,374,234; 4,981,927; and 5,198,400. In another aspect, the polymerization reaction further comprises a co-catalyst. In some embodiments, the co-catalyst is selected from an alkylaluminum, alkylboron, alkyl lithium, or alkyl zinc compound. In some non-limiting examples, the co-catalyst is a trialkylboron compound having the general formula BR₃; a trialkylaluminum having the general formula AlR₃; a alkyllithium having the general formula LiR; or a dialkylzinc having the general formula ZnR₂; wherein each R is independently alkyl_{(C≦6)} or substituted alkyl_{(C≦6)} as those terms are defined herein or according to standard IUPAC nomenclature. In one embodiment, the trialkylboron compound is triethylboron. In a further embodiment, the polymerization reaction comprises adding from about 0.1 to about 1.5 ppm of the trialkylboron compound to the polymerization reaction. In one aspect, the polymerization reaction can take place in any appropriate reactor system. In some embodiments, the polymerization reaction is performed in a slurry loop or a single gas phase reactor system.

In some embodiments of the methods and processes as provided herein, the catalyst may have a mileage (e.g., the catalyst's ability to produce a certain amount of polymer per gram of catalyst used in the process) sufficient to produce from 500 to 10,000 grams of polyolefin per gram of catalyst. In some embodiments, the catalyst may have a mileage sufficient to produce 1,000 to 7,500 grams of polyolefin per gram of catalyst.

### VI. Process Scale-Up

The above methods can be further modified and optimized for preparative, pilot- or large-scale production, either batch or continuous, using the principles and techniques of process chemistry as applied by a person skilled in the art. Such principles and techniques are taught, for example, in Practical Process Research & Development (2012).

### VII. Definitions

The use of the word “a” or “an,” when used in conjunction with the term “comprising” in the claims and/or the specification may mean “one,” but it is also consistent with the meaning of “one or more,” “at least one,” and “one or more than one.”

Throughout this application, the term “about” is used to indicate that a value includes the variation of error for a device, the method being employed to determine a value, or the variation that exists among samples.

The term “alkyl” when used in the context of this application, is an aliphatic, straight or branched chain consisting of only carbon and hydrogen atoms consistent with standard IUPAC nomenclature. When the term is used in conjunction with the term “substituted,” one or more of the hydrogen atoms of the alkyl group has been replaced with —OH, —F, —Cl, —Br, —I, —NH₂, —NO ₂, —CO₂H, —CO₂CH₃, —CN, —SH, —OCH₃, —OCH₂CH₃, —C(O)CH₃, —NHCH₃, —NHCH₂CH₃, —N(CH₃)₂, —C(O)NH₂, —OC(O)CH₃, or —S(O)₂NH₂.

As used herein, the term “average molecular weight” refers to the relationship between the number of moles of each polymer species and the molar mass of that species. Each polymer molecule in a composition will have different levels of polymerization and thus a different molar mass. The average molecular weight can be used to represent the molecular weight of a plurality of polymer molecules. In particular, there are three major types of average molecular weight: average molar mass number (Mₙ), weight (or mass) average molar mass (M_{w}), and Z-average molar mass. In the context of this application, unless otherwise specified, the average molecular weight represents the weight average molar mass of the formula. As used herein, average molecular weight refers to the weight average molecular weight (M_{w}) as determined by gel permeation chromatography (GPC). In some embodiments, the weight of the polymers is described according to the ratio of the M_{w}/Mₙ, or the polydispersity index (PD or PDI).

The polymer property “butyl branching,” “short chain branching,” or “SCB” when used in the context of this application refers to the extent of branching of the polymer backbone with butyl or other alkyl groups from the incorporation of a co-monomer in a polyethylene polymer. Butyl branching is measured using gel permeation chromatography (also known as size exclusion chromatography) coupled with a light scattering detector, viscosity detector, or an infrared detector including a multiwavelength infrared detector as described in Yau et al. (2011) and Monrabal et al. (2009). Branching can also be measured by plotting log IV as a function of log M_{w} as measured by light scattering in a Mark-Houwink (MH) plot as described in Yau et al. (2001). The term “short chain branching” or “SCB” may also be used analogously as an occurrence where the polymer backbone is branched with other alkyl groups.

The terms “comprise,” “have” and “include” are open-ended linking verbs. Any forms or tenses of one or more of these verbs, such as “comprises,” “comprising,” “has,” “having,” “includes” and “including,” are also open-ended. For example, any method that “comprises,” “has” or “includes” one or more steps is not limited to possessing only those one or more steps and also covers other unlisted steps.

In the context of this application, “oxide solid components” refer to a solid component or components which contain oxygen and one or more elements selected from silicon, aluminum, titanium, boron, magnesium, fluorine, and zirconium. Some non-limiting examples include silicas, silica-aluminas, aluminas, zirconias, titanias, borias, magnesias, aluminum phosphates, and mixtures thereof. In some embodiments, the oxide solid component is a silica solid component. Non-limiting examples of suitable oxide solid components are described in U.S. Pat. Nos. 2,825,721; 3,819,811; 4,053,565; 4,177,162; 5,037,911; 6,147,171; 6,569,960; and U.S. Pat. App. Pub. No. 2013/0090437.

The polymer property “long chain branching index” or “LCBI” when used in the context of this application refers to a measurement of the amount of branching present in a polymer. LCBI is calculated as described in Shorff et al. (1999) or by using the formula:

LCBI=[ETA0^{0.179}/(4.8×IV)]−1 (I)

where ETA0 is the zero shear velocity from DORS and IV is the intrinsic velocity from GPC. Additionally, long chain branching is calculated using a method described by Arnett et al. (1980) in which log ETA0 is plotted against log M_{w(lin)} an Arnett plot.

A polymer property “melt index” or “MI” when used in the context of this application refers to the ease of flow of the melt of thermoplastic polymer. The measurement is defined as the mass of a polymer in grams flowing in ten minutes through a capillary of a specific diameter and length at a specific pressure and temperature. This property is described in further detail by ASTM D 1238 and ISO 1133. ASTM D 1238 is entitled “Test Method for Melt Flow Rates of Thermoplastics by Extrusion Plastometer.” The term “ASTM D 1238” as used herein refers to the standard test method for determining melt flow rates of thermoplastics by extrusion plastometer. In general, this test method covers the determination of the rate of extrusion of molten thermoplastic resins using an extrusion plastometer. After a specified pre-heating time, resin is extruded through a die with a specified length and orifice diameter under prescribed conditions of temperature, load, and piston position in the barrel. This test method was approved on February 1, 2012 and published March 2012, the contents of which are incorporated herein by reference in its entirety. Throughout the present description and claims, the standard “melt index” or “MI₂” values of polyethylene polymers are measured according to ASTM D 1238, using a piston load of 2.16 kg and at a temperature of 190° C.

The “High Load Melt Index” (or “HLMI” or “MI_{2.16}”) values are also measured according to ASTM D 1238, but using a piston load of 21.6 kg and at a temperature of 190° C. Throughout the present description and claims, the standard melt flow rate values of polypropylene polymers are measured according to ASTM D 1238, using a piston load of 2.16 kg and at a temperature of 230° C.

A “method” is series of one or more steps undertaking lead to a final product, result or outcome. As used herein, the word “method” is used interchangeably with the word “process.”

The property “MIR” is the melt index ratio or HLMI/MI. The property “PD” or “PI” is the polydispersity index or M_{w}/Mₙ. The property “PDR” is described in Shroff et al. (1995), the contents of which are incorporated herein by reference in their entirety. In some embodiments, the final polyolefin composition may have a PDR from 10 to 60, including from 12 to 40.

In some embodiments, the final polyolefin composition may have an Er ranging from about 2 to 6, or from 3 to about 5. The property “ER” is a measure of the polymer melt rheological polydispersity as described in Shroff et al. (1995). Er can be measured according to the following procedure: a standard practice for measuring dynamic rheology data in the frequency sweep mode as described in ASTM 4440-95a may be employed. A Rheometrics ARES rheometer may be used, operating at 150-190° C., in the parallel plate mode in a nitrogen environment (in order to minimize sample oxidation/degradation). In a non-limiting example, the gap in the parallel plate geometry may be 1.2-1.4 mm, the diameter of the plates may be 25 mm or 50 mm and the strain amplitude may be 10-20%, with a range of frequencies from 0.0251 to 398.1 rad/sec. As disclosed in Shroff et al. (1995) and U.S. Pat. No. 5,534,472, ER is calculated from the storage modulus (G′) and loss modulus (G″) data, as follows: the nine lowest frequency points are used (5 points per frequency decade) and a linear equation is fitted by least-squares regression to log G′ versus log G″. ER is then calculated from the following equation:

ER=(1.781×10⁻³)×G′, at a value of G″=5,000 dyn/cm² (II)

Those skilled in the art will appreciate that when the lowest G″ value is greater than 5,000 dyn/cm², the above ER calculation involves an extrapolation that may result in different ER values depending on the degree of nonlinearity in the log G′ versus log G″ plot. The procedure followed was to select the temperature, plate diameter and frequency range such that the lowermost loss modulus value (G″) is as close as, or ideally lower than, the value of 5,000 dyn/cm², within the resolution of the Rheometrics® ARES rheometer. For the examples listed herein, a temperature of 190° C., plate diameter of 50 mm, strain amplitude of 10% and frequency range of 0.0251 to 398.1 rad/sec, was typically adequate.

The term “olefin” as used in this application refers to an alkene or aralkene wherein at least one carbon-carbon double bond in the molecule is a terminal double bond. Some non-limiting examples of olefins include styrene, ethylene, propylene, butene, pentene, hexene, heptene, octene, nonene, decene, or dodecene.

The above definitions supersede any conflicting definition in any reference that is incorporated by reference herein. The fact that certain terms are defined, however, should not be considered as indicative that any term that is undefined is indefinite. Rather, all terms used are believed to describe the appended claims in terms such that can be appreciated by one of ordinary skill in the art.

### EXAMPLES

The following examples are included to demonstrate embodiments of the appended claims. Those of skill in the art should appreciate that many changes can be made in the specific embodiments which are disclosed and still obtain a like or similar result without departing from the spirit and scope of the disclosure herein.

### Example 1

### Polymerization of Olefins with Chromium Catalysts

Activation Procedure A: The catalysts were lab activated in a fluidized bed activator with a 25 cm diameter quartz tube with a sintered frit as the grid plate. The high hold temperatures are noted in the table. An activation cycle entails heating 10 grams of catalyst under N₂ from 25° C. to 150° C. at 1° C/min and a 3 hour hold at 150° C. The temperature is then ramped up at 100° C/hr. to 540° C. and the air switched on. The heating continues to the high temperature hold where it is held for 6 hours. Cooling is at a 1° C/min. rate down to about 315° C. and the air switched off and replaced by N₂ gas. The catalyst is cooled to room temperature and discharged from the activator under N₂ and stored until use.

Catalyst of Examples 7 and 8 was prepared as a physical blend of 0.4 grams of the catalyst of Example 1 and 0.6 grams of the catalyst of Example 9.

Catalyst of Examples 5 and 6 was prepared by Activation Procedure A. First, 4 grams of CAT 122 was activated at 870° C. After cooling to 25° C., 6 grams of CAT 118 were added to the activator and the mixture activated at 540° C.

TABLE 1
Catalysts and Activation Temperatures

| | | Activation |
|---|---|---|
| Example | Catalyst | Temperature (° C.) |
| Example 1 | CAT 122 | 870° C. |
| Example 2 | CAT 122 | 870° C. |
| Example 3 | CAT 071 | 600° C. |
| Example 4 | CAT 071 | 600° C. |
| Example 5 | Activation 4 parts CAT 122 with | — |
| | 6 parts CAT 118* | |
| Example 6 | Activation 4 parts CAT 122 with | — |
| | 6 parts CAT 118* | |
| Example 7 | Physical blend 4 parts Example 1 | — |
| | with 6 parts of Example 9 | |
| Example 8 | Physical blend 4 parts Example 1 | — |
| | with 6 parts of Example 9 | |
| Example 9 | CAT 118 | 540° C. |

*Catalyst was activated according to Activation Procedure A.

Polymerization runs were conducted in a 2 liter bench scale reactor with [C2=] at 9.4 mole % at 89.3° C. Some runs were optionally conducted with [TEB] co-catalyst and/or optionally with [H₂] and [C6=], as specified in the Table 2. The runs were 1 hour with the catalyst injected into the reactor with the other reaction components, including co-catalysts, already in the reactor and at the temperature of 89.3° C.

Examples 1-4 are control catalysts based on a single catalyst component. Catalyst of Examples 1 and 2 is a catalyst that produces high levels of long chain branching (LCB) and when it copolymerizes does not incorporate as much co-monomer in the higher M_{W} species of the polymer. Catalyst of Examples 3 and 4 is a catalyst that produces lower levels of long chain branching (LCB) and when it copolymerizes incorporates a higher level co-monomer in the higher M_{W} species of the polymer. Both catalysts incorporate more co-monomer in the higher M_{W} side of the MWD when polymerized with H₂.

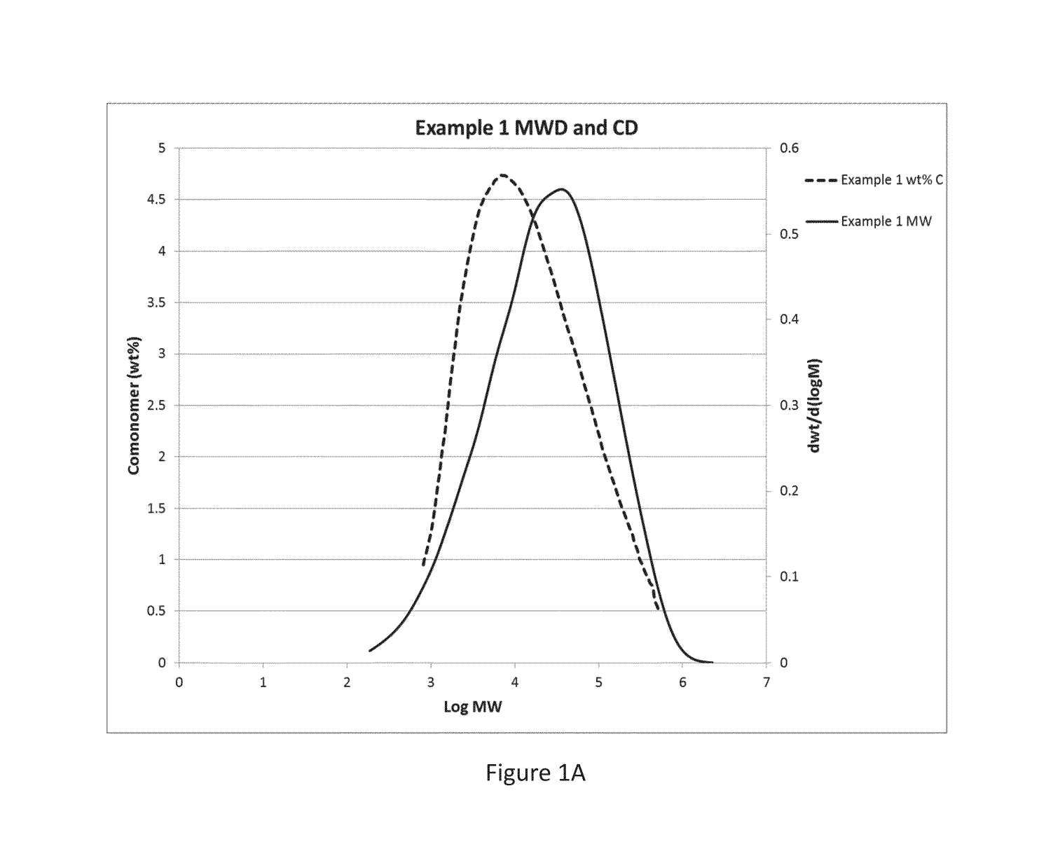

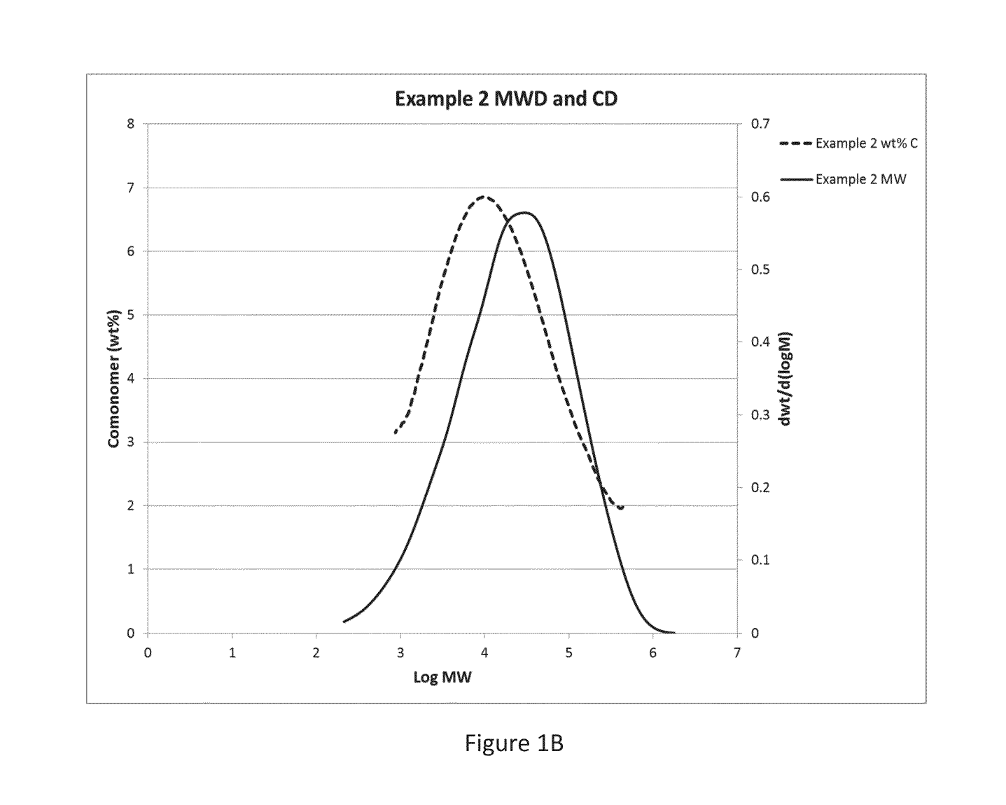

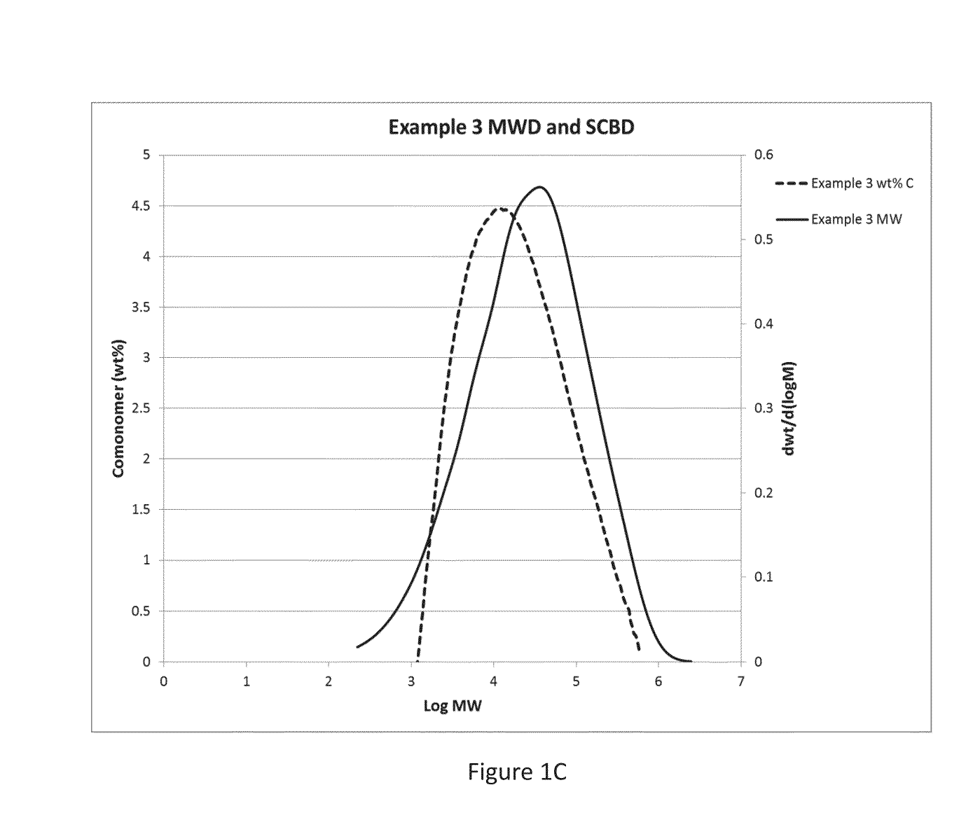

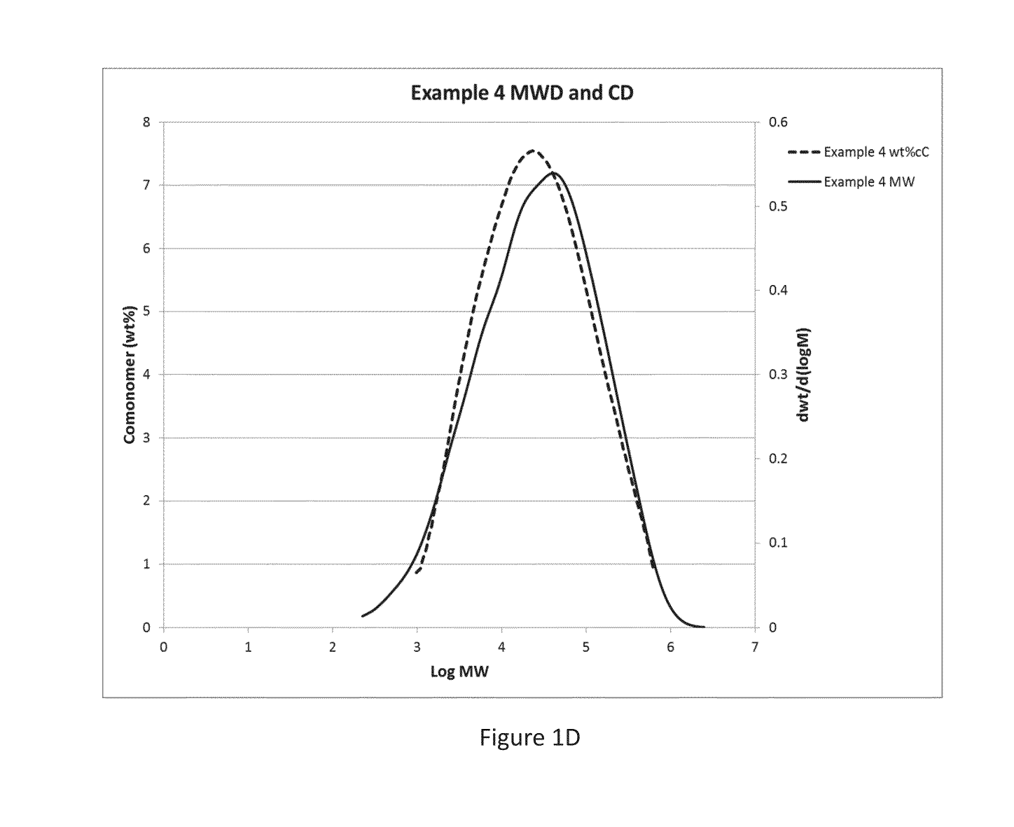

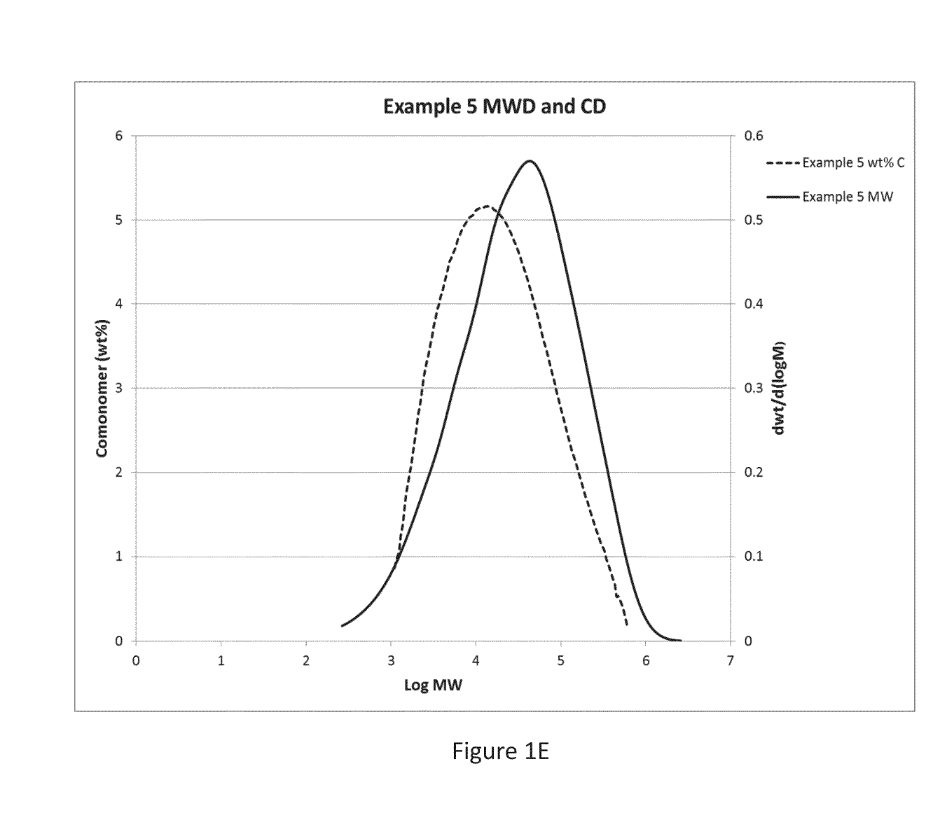

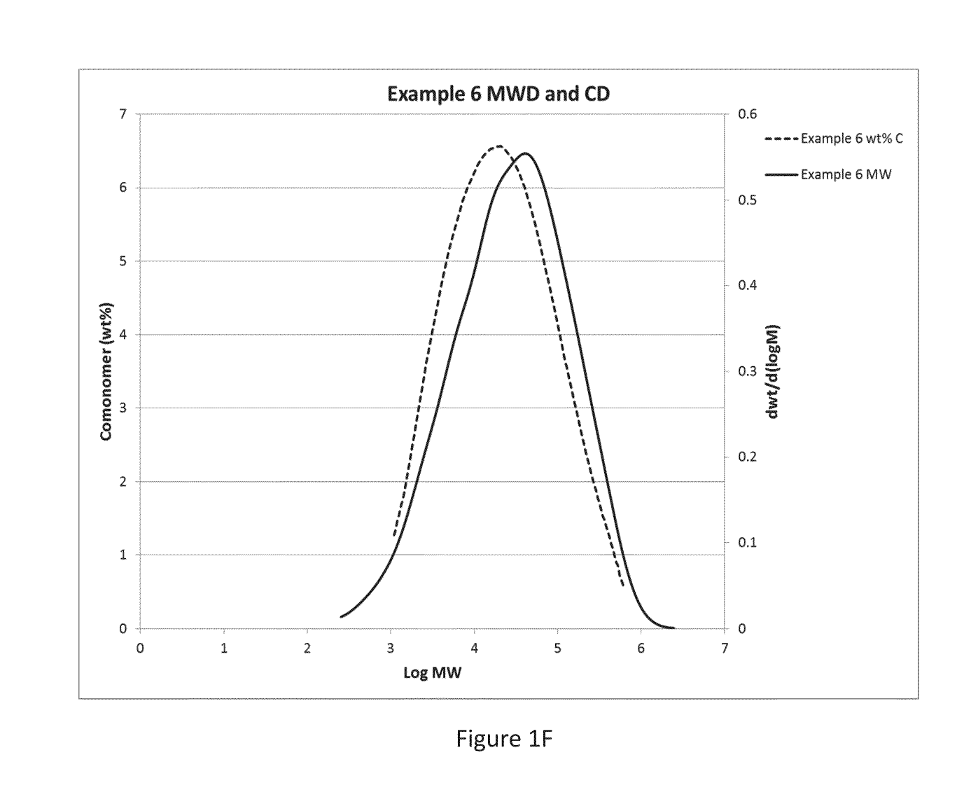

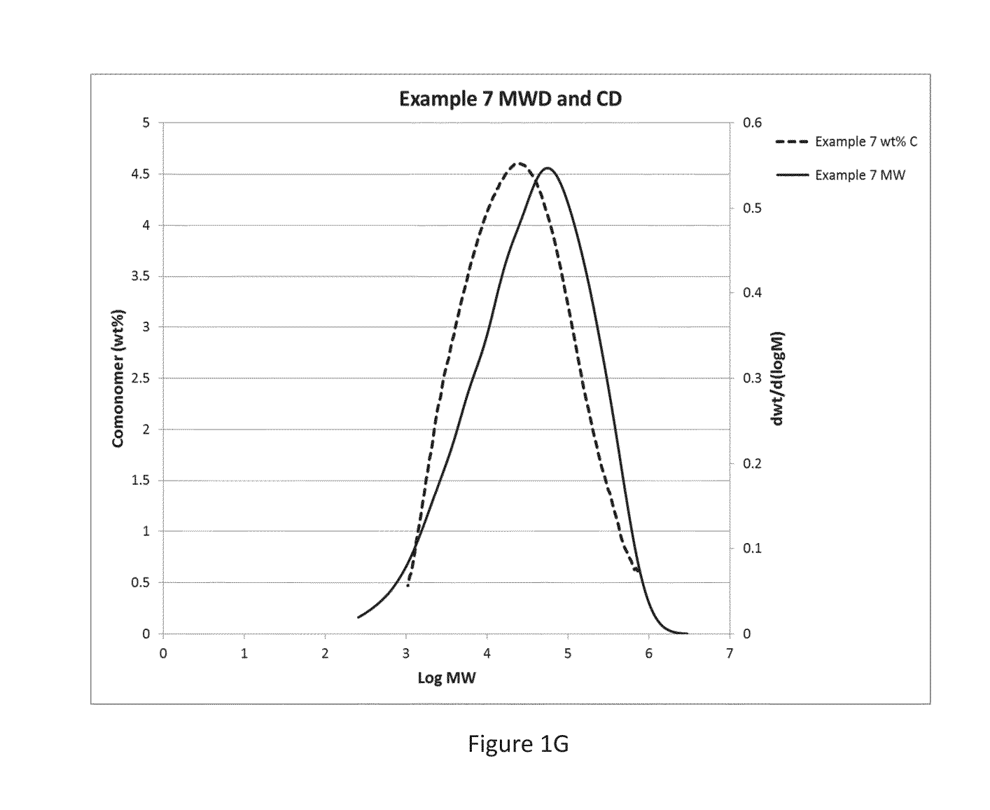

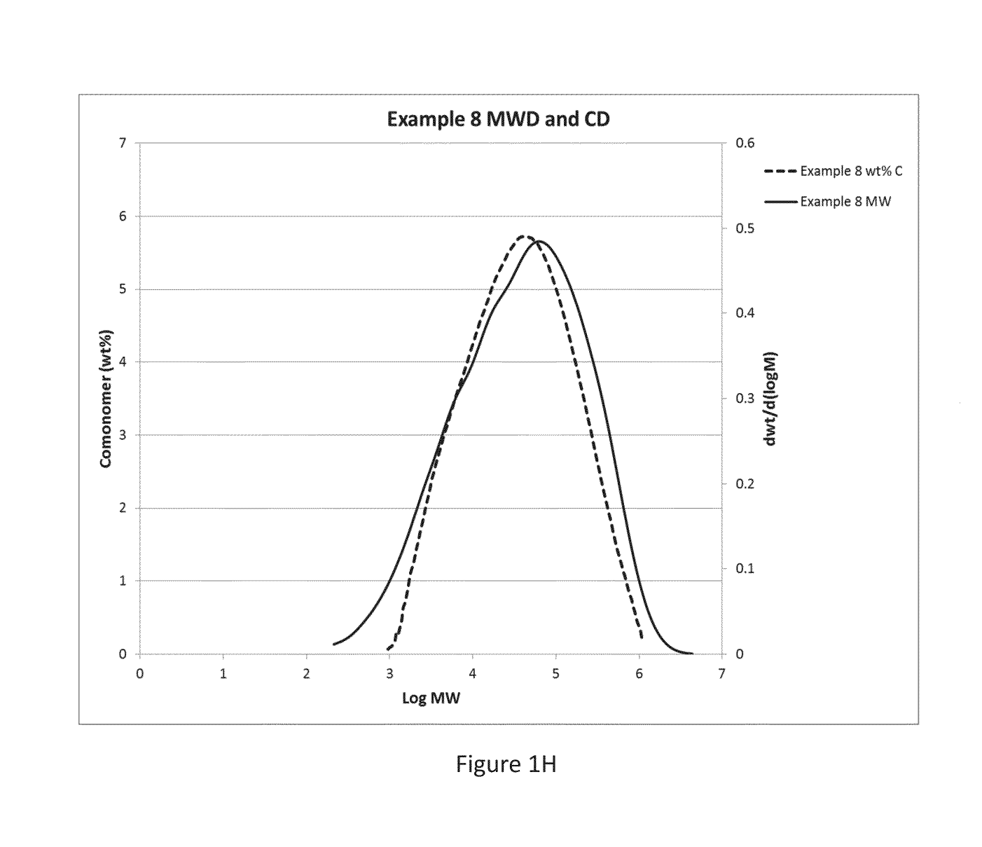

Examples 5-8 are the new catalyst compositions. Catalyst of Examples 5 and 6 is the catalyst from the activation procedure while catalyst of Examples 7 and 8 is the physical blend of separately activated catalysts. Catalyst of Examples 5 and 6 is a catalyst that incorporates a higher level co-monomer in the higher MW species of the polymer versus the catalyst of Examples 1 and 2. Of these examples, the catalysts of Examples 7 and 8 produced a polymer composition with the highest amount of polymer molecules in the higher MW range. Both catalysts incorporate more co-monomer in the higher MW side of the MWD when polymerized with H₂. These properties are shown in Table 2 and FIG. 1A-1H.

TABLE 2
Size Distribution and Co-Monomer Incorporation for Samples 1-8

| | % PE | % comonomer | | H₂ | C₆= | TEB |
|---|---|---|---|---|---|---|
| Example | >300,000 MW | in polymer >300,000 MW | Catalyst | (dP) | (mLs) | (ppm) |
| Example 1 | 4.8% | 2.4% | control CAT 122 (870° C.) | 0 | 30 | 0.75 |
| Example 2 | 3.6% | 2.9% | control CAT 122 (870° C.) | 340 | 30 | 0.75 |
| Example 3 | 5.9% | 2.2% | CAT 071 (600° C.) | 0 | 30 | 0.75 |
| Example 4 | 6.3% | 4.6% | CAT 071 (600° C.) | 340 | 30 | 0.75 |
| Example 5 | 6.8% | 2.5% | activated CAT 122 (870° C.) | 0 | 30 | 0.75 |
| | | | CAT 118 (540° C.) 4:6 | | | |
| Example 6 | 6.4% | 3.4% | activated CAT 122 (870° C.), | 340 | 30 | 0.75 |
| | | | CAT 118 (540° C.) 4:6 | | | |
| Example 7 | 8.9% | 5.0% | mix CAT 122 (870° C.) CAT | 0 | 30 | 0.75 |
| | | | 118 (540° C.) 4:6 | | | |
| Example 8 | 13.0% | 8.1% | mix CAT 122 (870° C.), CAT | 340 | 30 | 0.75 |
| | | | 118 (540° C.) 4:6 | | | |

### Example 2

### Evaluation of Long Chain Branching

Blow molding swell is one measure of the effectiveness of a polymer in the blow mold market. Three methods are routinely used to gauge the long chain branching (LCB) that correlates to blow molding die swell. The level of LCB in a film grade polymer can influence ease of processability as well as bubble stability. Methods of determining LCB use data from both GPC and DORS rheology.

In the long chain branching evaluation, the catalysts described in Table 3 were used in the studies described herein.

TABLE 3
Catalyst Used in Evaluation of Long Chain Branching

| | Pore Volume | Surface Area | | [Ti] | [Zr] |
|---|---|---|---|---|---|
| Catalyst | (g/mL) | (M²/g) | [Cr] wt. % | wt. % | wt. % |
| CAT 124 | 2.3 | 485 | 1.0 | 2.5 | — |
| CAT 122 | 2.3 | 580 | 1.0 | 4.0 | — |
| CAT 068 | 2.2 | 500 | 1.0 | 2.5 | — |
| CAT 097 | 1.4 | 300 | 1.0 | 0.0 | 2.0 |
| CAT 118 | 2.1 | 863 | 1.0 | 0.0 | — |

These catalysts were activated at the temperatures described in Table 4 or alternatively at the temperatures described in Table 5.

TABLE 4
Activation of Catalysts in Evaluation of Long Chain Branching

| Catalyst | Activation Temperature (° C.) |
|---|---|
| CAT 124 | 800 |
| CAT 122 | 870 |
| CAT 071 | 800 |
| CAT 097 | 600 |
| CAT 118 | 540 |

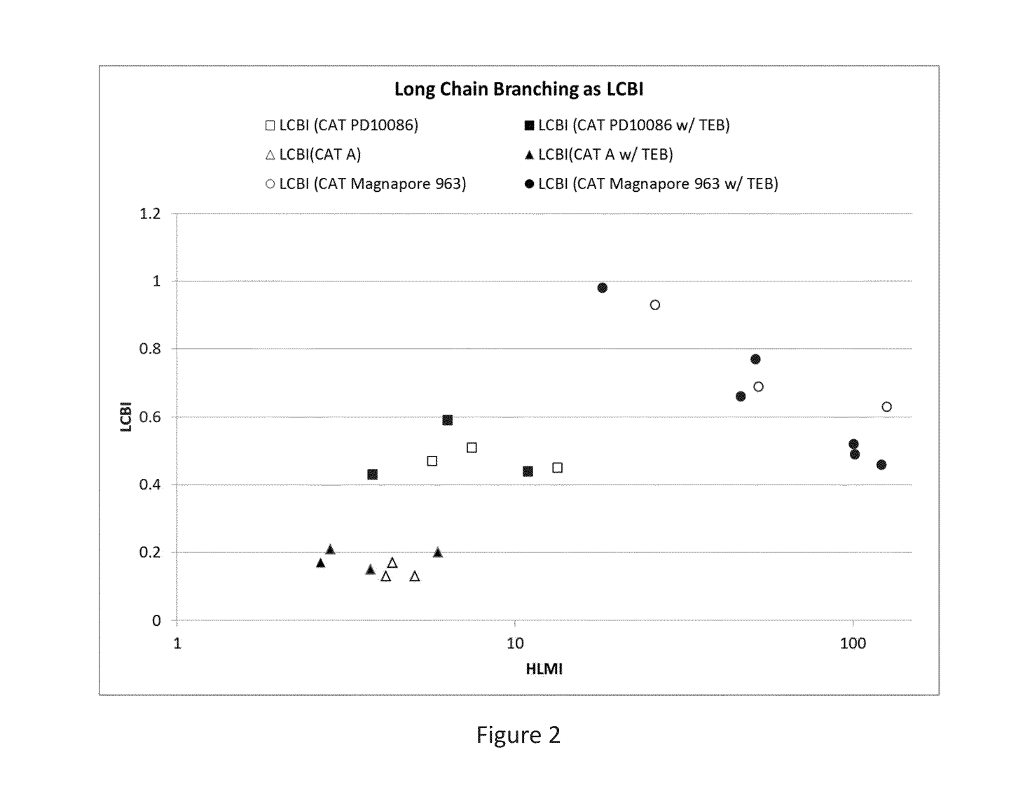

Three catalysts were evaluated for LCB over a wide range of temperatures with and without TEB cocatalyst to produce a wide range of HLMI or M_{w}. The data is summarized in FIG. 2. Of these examples, the catalyst CAT 124 made a polymer composition having a higher MI (lower M_{w}) and higher LCBI polymers as compared to the two other catalysts. In some embodiments, CAT 124 may be used for making the higher HLMI component. In some embodiments, the other two catalysts may be used for making the lower HLMI component. These catalysts were analyzed as shown in Table 6.

TABLE 5
Alternative Activation Temperatures (° C.)
for the Catalyst Described in Table 3

| Catalyst | Activation Temperature (° C.) |
|---|---|
| CAT 124 | 800 |
| CAT 097 | 600 |
| CAT 118 | 540 |

TABLE 6
Catalyst Polymerization Conditions and Resultant Polymer Properties

| | | Reactor | Reactor | | | | | | | | | |
|---|---|---|---|---|---|---|---|---|---|---|---|---|
| | TEB | temp. | pressure | Productivity | | | | | | PD | Mw | |
| Catalyst | (mls) | (° C.) | (MPa) | gPE/g cat | MI | HLMI | MIR | PDR | ER | (Lin) | (Lin) | LCBI |
| CAT 118 | 0.20 | 95 | 2.82 | 676 | — | 2.8 | — | 74.1 | 3.9 | 33.2 | 379,120 | 0.21 |
| CAT 118 | 0.20 | 95 | 2.82 | 545 | — | 2.7 | — | 66.1 | 3.7 | 27.8 | 374,837 | 0.17 |
| CAT 118 | 0.00 | 95 | 2.82 | 261 | — | 4.2 | — | 59.4 | 3.7 | 26.7 | 370,867 | 0.13 |
| CAT 118 | 0.20 | 105 | 3.27 | 1542 | — | 5.9 | — | 39.6 | 3.5 | 20.8 | 314,958 | 0.20 |
| CAT 118 | 0.00 | 105 | 3.27 | 667 | — | 5.1 | — | 28.8 | 3.2 | 19.4 | 315,174 | 0.13 |
| CAT 118 | 0.00 | 100 | 3.03 | 393 | — | 4.4 | — | 41.3 | 3.6 | 24.4 | 336,221 | 0.17 |
| CAT 118 | 0.20 | 100 | 3.03 | 947 | — | 3.7 | — | 43.3 | 3.4 | 21.1 | 340,828 | 0.15 |
| CAT 124 | 0.00 | 100 | 3.03 | 1785 | 0.59 | 52.5 | 90 | 24.8 | 3.5 | 11.0 | 138,502 | 0.69 |
| CAT 124 | 0.20 | 100 | 3.03 | 2704 | 0.48 | 46.7 | 86 | 26.2 | 3.6 | 11.7 | 159,095 | 0.66 |
| CAT 124 | 0.20 | 100 | 3.03 | 2893 | 0.59 | 51.6 | 88 | 24.5 | 3.4 | 9.6 | 131,756 | 0.77 |
| CAT 124 | 0.00 | 105 | 3.27 | 1424 | 2.11 | 126.2 | 60 | 16.1 | 3.2 | 7.9 | 100,315 | 0.63 |
| CAT 124 | 0.20 | 105 | 3.27 | 3902 | 1.54 | 101.5 | 66 | 17.1 | 3.2 | 9.9 | 122,334 | 0.49 |
| CAT 124 | 0.00 | 95 | 2.82 | 1714 | 0.21 | 25.9 | 123 | 36.8 | 4.0 | 11.5 | 156,651 | 0.93 |
| CAT 124 | 0.20 | 95 | 2.82 | 1858 | 0.10 | 18.1 | 174 | 43.3 | 4.3 | 9.6 | 167,442 | 0.98 |
| CAT 097 | 0.20 | 95 | 2.82 | 1895 | — | 3.8 | — | 119.0 | 5.1 | 21.4 | 311,891 | 0.43 |
| CAT 097 | 0.00 | 95 | 2.82 | 1156 | — | 5.7 | — | 103.1 | 4.9 | 20.1 | 295,055 | 0.47 |
| CAT 097 | 0.20 | 105 | 3.27 | 1937 | — | 10.9 | — | 44.1 | 4.1 | 16.5 | 246,958 | 0.44 |
| CAT 097 | 0.00 | 105 | 3.27 | 1095 | — | 13.4 | — | 43.0 | 4.0 | 15.2 | 236,733 | 0.45 |
| CAT 097 | 0.00 | 100 | 3.03 | 946 | — | 7.4 | — | 64.8 | 4.4 | 16.4 | 257,276 | 0.51 |
| CAT 097 | 0.20 | 100 | 3.03 | 1834 | — | 6.3 | — | 74.9 | 5.0 | 17.5 | 262,157 | 0.59 |

A second catalyst was evaluated for the high HLMI component. The long chain branching data is summarized in the figure. The data shows that CAT 122 activated at 870° C. exhibits very high levels of LCBI. In some embodiments, CAT 122 may be used to make the higher HLMI (lower M_{w}) component. In general, as the HLMI decreases for a given catalyst the level of LCBI measured increases. The mixed catalysts were evaluated for LCB compared to each of their component parts.

TABLE 7
Polymerization with No Hydrogen and 5 mL of Co-Monomer (Hexene)

| | | Reactor | Reactor | | | | | | | | | |
|---|---|---|---|---|---|---|---|---|---|---|---|---|
| | TEB | temp. | pressure | Productivity | | | | | | PD | Mw | |
| Catalyst | (mls) | (° C.) | (MPa) | gPE/g cat | MI | HLMI | MIR | PDR | Er | (Lin) | (Lin) | LCBI |
| CAT 118 | 0.2 | 10 | 2.91 | 2925 | | 7.8 | — | 84.3 | 4.2 | 20.2 | 15638 | 0.48 |
| CAT 121 | 0.2 | 10 | 2.91 | 2561 | 0.097 | 12.8 | 131.57 | 64.7 | 4.7 | 18.7 | 14716 | 0.43 |
| CAT 124 | 0.2 | 10 | 2.91 | 1511 | 1.34 | 99.5 | 74.27 | 40.9 | 5.0 | 12.5 | 10537 | 1.21 |

TABLE 8
Polymerization with 50 psi (344737.9 Pa) Δp of Hydrogen and 5 mL of Co-Monomer (Hexene)

| | | Reactor | Reactor | | | | | | | | | |
|---|---|---|---|---|---|---|---|---|---|---|---|---|
| | TEB | temp. | pressure | Productivity | | | | | | PD | Mw | |
| Catalyst | (mls) | (° C.) | (MPa) | gPE/g cat | MI | HLMI | MIR | PDR | Er | (Lin) | (Lin) | LCBI |
| CAT 118 | 0.2 | 100 | 2.94 | 2691 | — | 7.0 | — | 54.9 | 3.8 | 19.57 | 15475 | 0.37 |
| CAT 118 | 0.2 | 100 | 2.94 | 2771 | 0.04 | 6.0 | 137 | 52.9 | 3.6 | 18.25 | 15993 | 0.37 |
| CAT 121 | 0.2 | 100 | 2.94 | 3297 | 0.15 | 15.2 | 101 | 38.2 | 4.1 | 18.01 | 12868 | 0.4 |
| CAT 123 | 0.2 | 100 | 2.94 | 2294 | 0.10 | 13.8 | 133 | 48.0 | 4.0 | 17.75 | 14161 | 0.36 |
| CAT 124 | 0.2 | 100 | 2.94 | 1465 | 1.92 | 138.0 | 72 | 28.9 | 4.2 | 12.49 | 9697 | 0.98 |

TABLE 9
Polymerization with 340 psi (2344217.5 Pa) Δp of Hydrogen and 5 mL of Co-Monomer (Hexene)

| | | Reactor | Reactor | | | | | | | | | |
|---|---|---|---|---|---|---|---|---|---|---|---|---|
| | TEB | temp. | pressure | Productivity | | | | | | PD | Mw | |
| Catalyst | (mls) | (° C.) | (MPa) | gPE/g cat | MI | HLMI | MIR | PDR | Er | (Lin) | (Lin) | LCBI |
| CAT 121 | 0.05 | 100 | 3.03 | 1786 | 0.45 | 32.3 | 71.7 | 24.3 | 3.7 | 14.05 | 12353 | 0.46 |
| CAT 122 | 0.05 | 100 | 3.03 | 2028 | 1.67 | 104.0 | 62.3 | 21.73 | 3.5 | 10.05 | 11231 | 0.57 |
| CAT 123 | 0.05 | 100 | 3.03 | 1015 | 0.16 | 20.0 | 126.6 | 27.88 | 3.3 | 21.77 | 10284 | 0.28 |
| CAT 124 | 0.05 | 100 | 3.03 | 2974 | 2.69 | 148.9 | 55.4 | 12.67 | 2.9 | 8.33 | 12269 | 0.63 |
| CAT 118 | 0.2 | 100 | 3.03 | 1849 | 0.08 | 8.9 | 110.2 | 36.49 | 3.7 | 17.62 | 15679 | 0.29 |
| CAT 118 | 0.2 | 100 | 3.03 | 2553 | 0.11 | 10.3 | 93.5 | 35.5 | 3.5 | 17.23 | 15554 | 0.30 |
| CAT 121 | 0.2 | 100 | 3.03 | 3188 | 0.47 | 32.8 | 70.2 | 27.63 | 3.5 | 17.74 | 11997 | 0.25 |
| CAT 122 | 0.2 | 100 | 3.03 | 1617 | 1.49 | 107.3 | 72.0 | 27.35 | 3.8 | 11.63 | 10724 | 0.64 |
| CAT 123 | 0.2 | 100 | 3.03 | 1452 | 0.17 | 15.2 | 87.1 | 26.45 | 3.4 | 20.19 | 12712 | 0.16 |

Without being bound by any theory, the above data indicates that the polymer properties can be further tailored according to the level of TEB co-catalyst.

### Example 3

### Same Catalyst Activated at Two Different Activation Temperatures (Physical Blend)

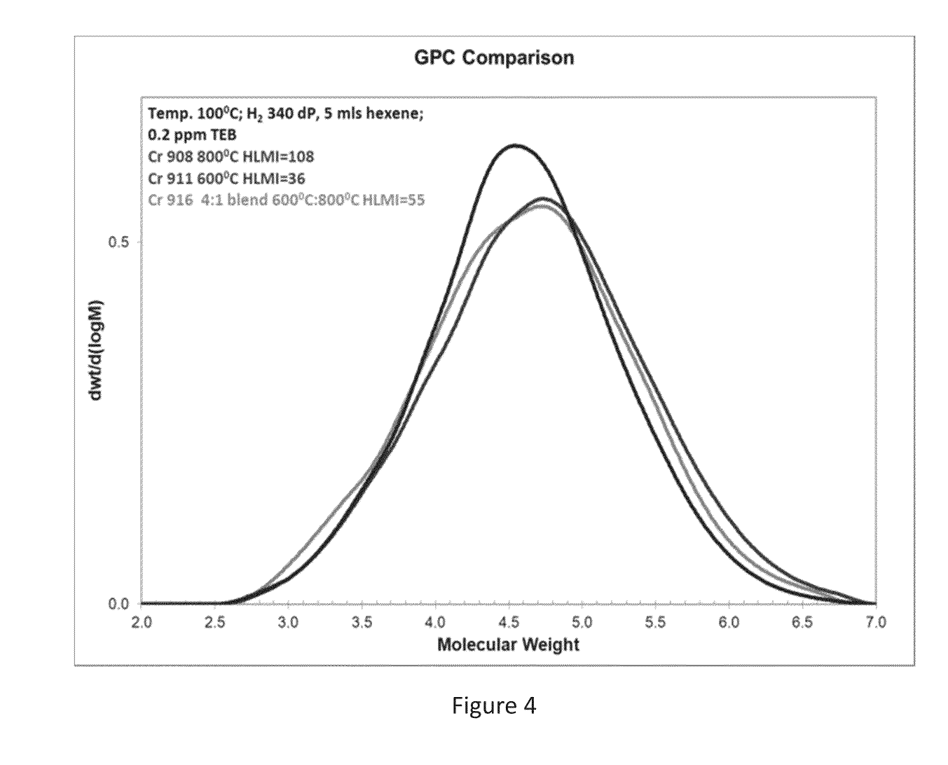

CAT 071, PV=2.3 ml/g, SA 500 M²/g 2.5wt. % Ti was activated at 600° C. or 800° C. The individual catalysts were then tested under the same conditions and compared to a post activation physical blend. Tables 10-12 and FIG. 4 provide summaries of the data. The observed MI, HLMI, and mileage of the catalyst is described in Table 12. The GPC data shows the polymer has an MWD which is intermediate between the two components (FIG. 4).

TABLE 10
Characteristics of the Catalyst Individually when
Activated at Different Temperatures

| Activation Temperature (° C.) | MI | HLMI | Mileage (g PE/g cat) |
|---|---|---|---|
| 800 | 1.91 | 108 | 3853 |
| 600 | 0.45 | 36 | 2201 |

TABLE 11
Estimated Characteristics of the Catalyst Composition
(Physical Blend of 4 parts 600° C. activated catalyst
and 1 part 800° C. activated catalyst)

| % high MI PE | % cat. by wt | Calculated Mileage (g PE/g cat) |
|---|---|---|
| 30% | 20% | 2531 |

TABLE 12
Characteristics of the Catalyst Composition (Physical
Blend of 4 parts 600° C. activated catalyst and
1 part 800° C. activated catalyst)

| | MI | HLMI | Mileage (g PE/g cat) |
|---|---|---|---|
| Estimated | 0.69 | 51 | 2531 |
| Observed | 0.81 | 55 | 2589 |

### Example 4

### Two Different Catalyst Chemistries Activated at Different Temperatures (Physical Blend)

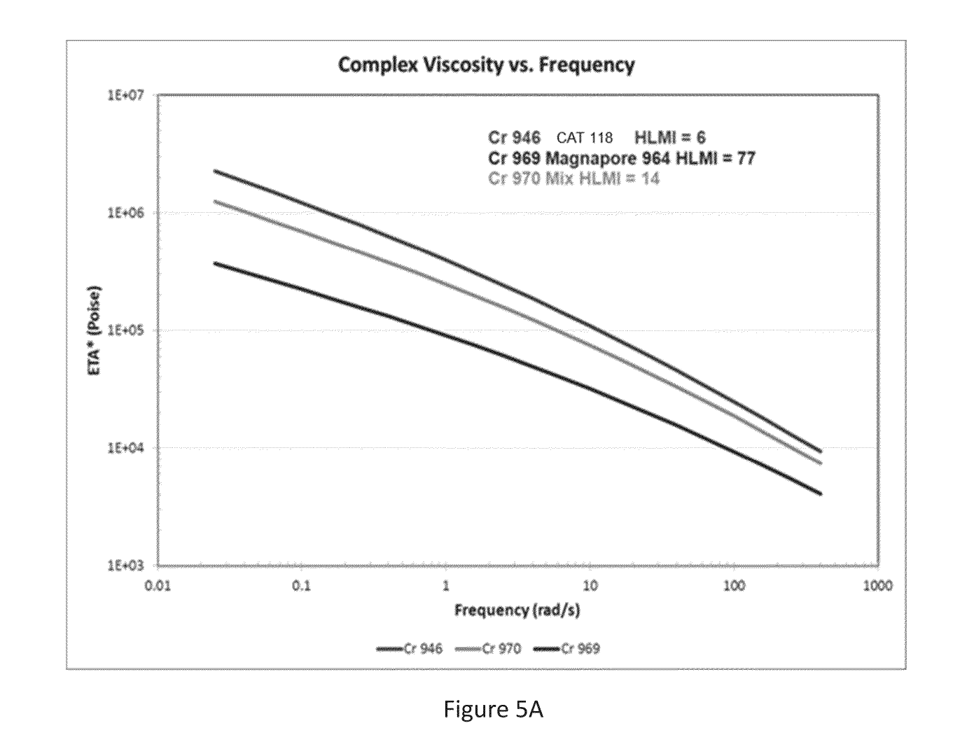

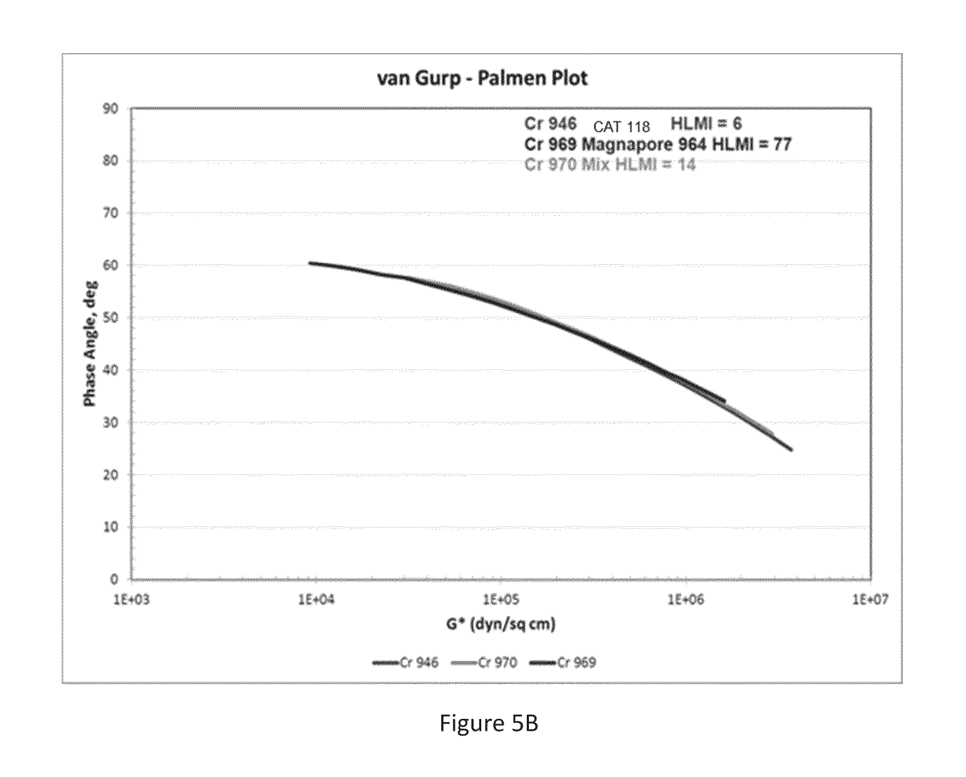

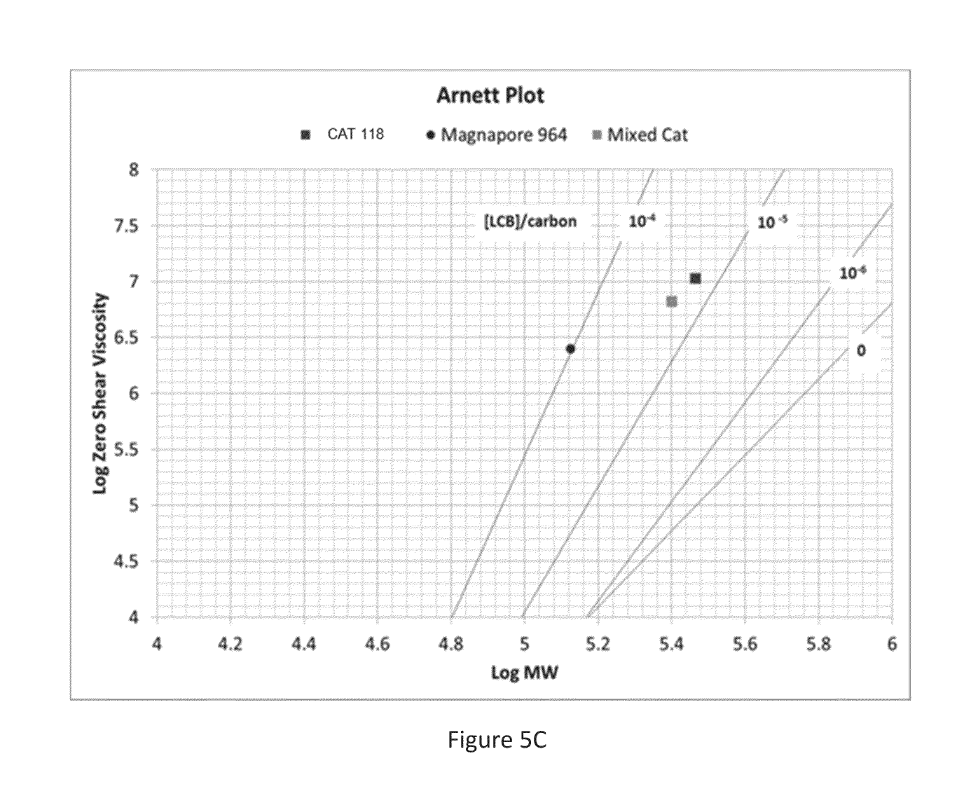

The catalysts are selected from: a high MI catalyst CAT 122 (4 wt. % Ti) activated at 800° C. and a low MI Catalyst CAT 118 activated at 540° C. The individual catalysts were tested and compared to a post activation physical blend with a low concentration of H₂ at 50 psi (344737.9 Pa) ΔP. The data is shown in Tables 13-15 and FIGS. 5A-5C. The mixed catalyst estimated and observed mileage and HLMI are shown in Table 15. The rheology data shows the mixed catalyst produces a material of intermediate viscosity (FIG. 5A), while the van-Gurp Palmen plot (FIG. 5B) shows the polymers have similar phase angle. The Arnett Plot (FIG. 5C) shows the mixed catalyst made polymer having an intermediate level of long chain branching.

TABLE 13
Characteristics of the Catalyst Individually when
Activated at Different Temperatures

| Catalyst | MI | HLMI | Mileage (g PE/g cat) |
|---|---|---|---|
| CAT 122 | 1.9 | 77 | 1548 |
| CAT 118 | — | 6 | 2721 |

TABLE 14
Estimated Characteristics of the Catalyst Composition
(Physical Blend of 60% CAT 118 and 40% CAT 122)

| % High MI PE | % cat. by wt | Calculated Mileage (g PE/g cat) |
|---|---|---|
| 27% | 40% | 2282 |

TABLE 15
Characteristics of the Catalyst Composition
(Physical Blend of 60% CAT 118 and 40% CAT 122)

| | MI | HLMI | Mileage (g PE/g cat) |
|---|---|---|---|
| Estimated | — | 12 | 2282 |
| Observed | — | 14 | 2294 |

### Example 5

### “In Activator Mixing” Activation Procedure

Without being bound by any theory, it is contemplated that once a catalyst is activated at a high temperature a subsequent additional heat cycle at a lower temperature will make minimal change to the catalyst performance. Furthermore, the titanium in the CAT 122 catalyst is not mobile in the activator, which prevents it from becoming bound to the second catalyst. This theory was evaluated using a composition prepared according to the following method:
Step One: Activate CAT 122 at 870° C. and cool down to 25° C.
Step Two: Charge 2^{nd} catalyst
Step Three: Activate at 540° C.

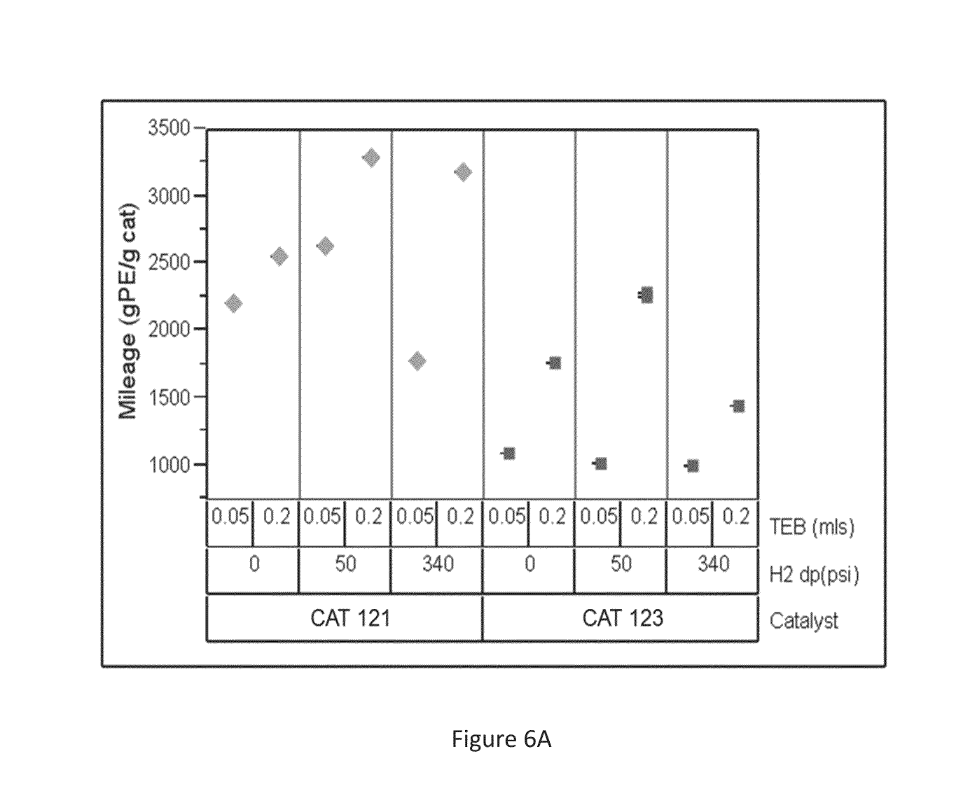

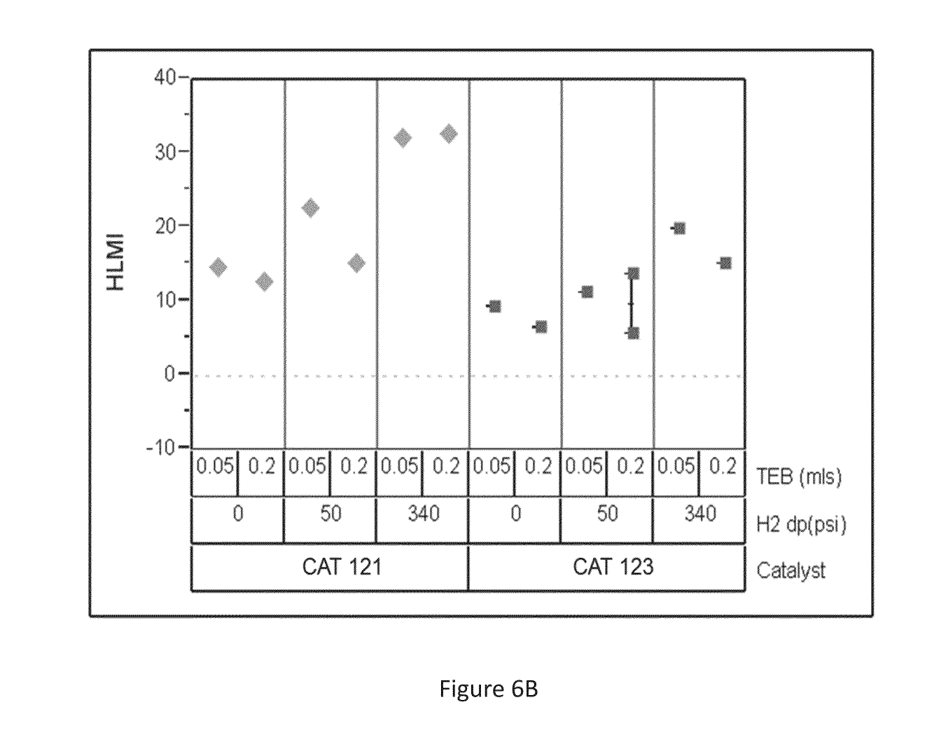

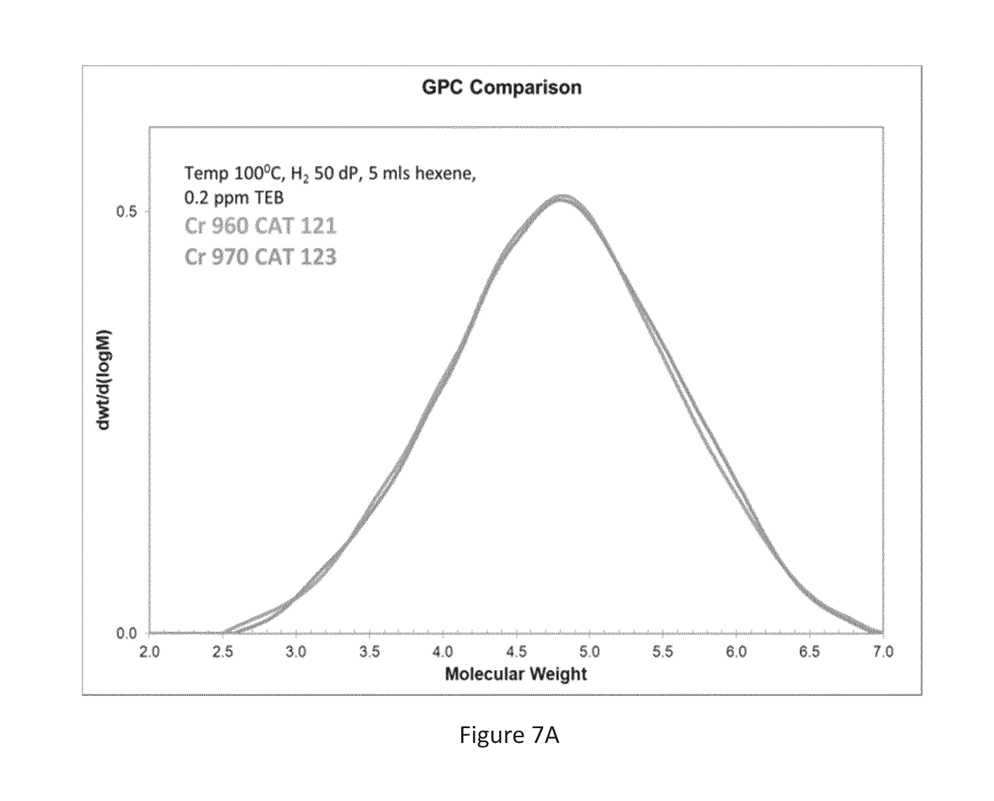

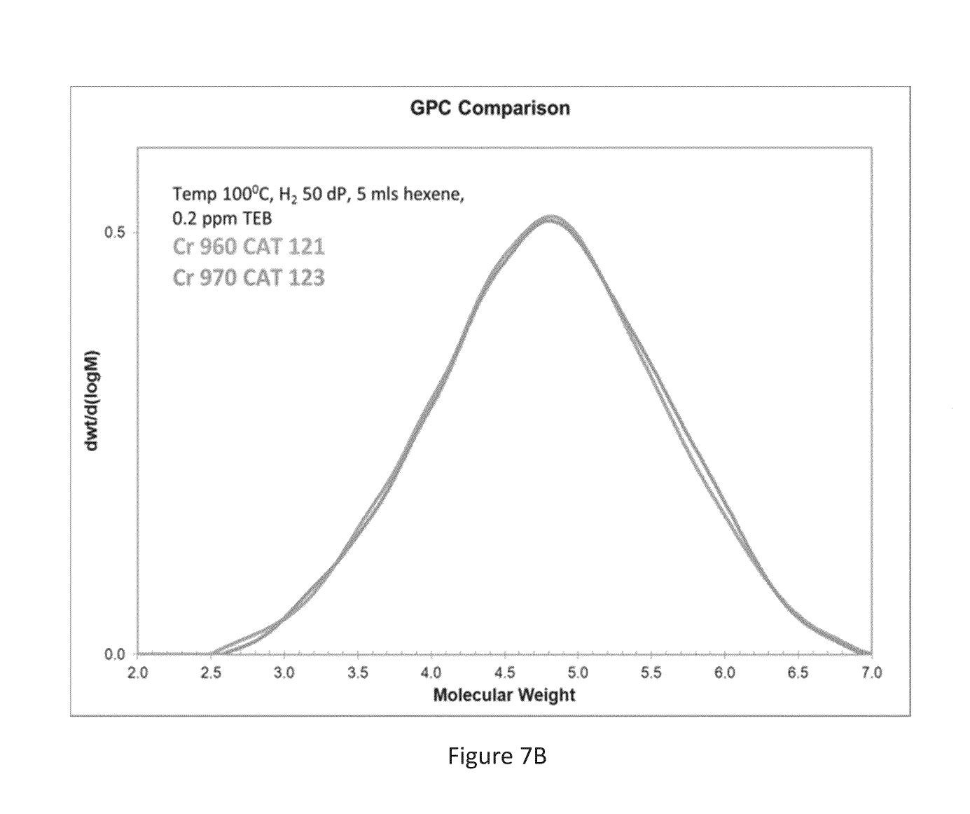

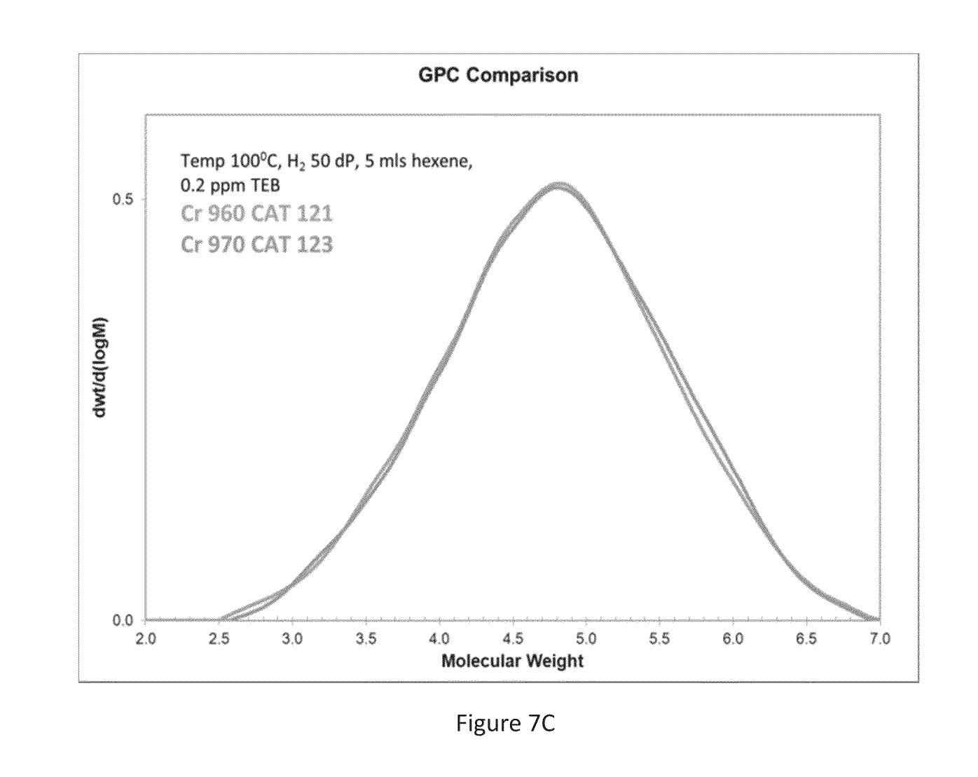

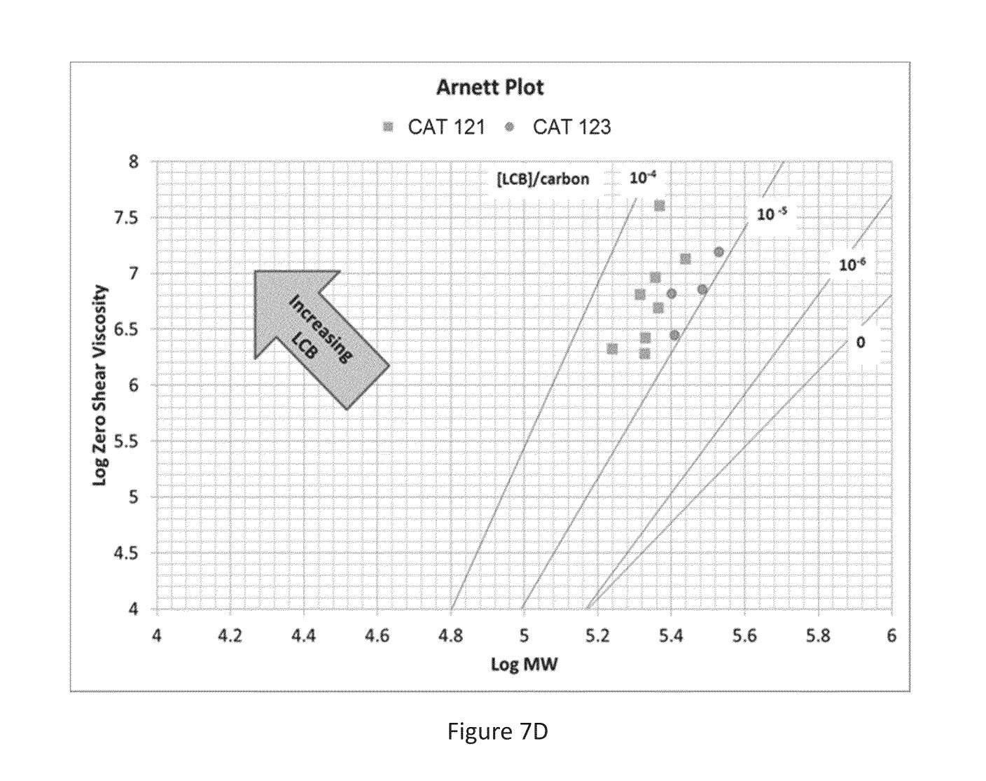

The activation catalyst was then isolated, with the mixing of both catalysts being done in the activator. The individually activated and activation catalysts were evaluated and the resultant data is shown in FIGS. 6A-6B, FIGS. 7A-7D, and Table 16. The catalyst CAT 121 is the activation catalyst from a three step process of 60% CAT 118 and 40% CAT 122 and blended in activator, while CAT 123 is the physical blend post activation catalyst of 60% CAT 118 and 40% CAT 122.

The catalysts were evaluated at three concentrations of H₂ and two different concentrations of triethylboron (TEB) (FIGS. 6A-6B). Based on the mileage and HLMI data, the catalysts are similar but do not behave exactly the same. CAT 121 exhibits higher mileage and higher HLMI potential with each condition tested. When comparing GPC data, the MWD is similar for both catalysts (FIG. 7A). The DORS data confirms the slightly better HLMI potential and corresponding lower viscosity (FIG. 7B). CAT 121 was found to be rheologically narrower (FIG. 7C). Based upon the obtained data, CAT 121 exhibited higher mileage, slightly higher HLMI potential and higher levels of LCB (from ARNETT plot analysis in FIG. 7D) than the physical blend catalyst (CAT 123).

TABLE 16
Characteristics of the Catalyst Composition
(Mixtures of 60% CAT 118 and 40% CAT 122)

| | Mixture | Catalyst ID | HLMI | Mileage (g PE/g cat) |
|---|---|---|---|---|
| Estimated | — | — | 12 | 2282 |
| Observed | Physical Blend | CAT 123 | 14 | 2294 |
| Observed | Activation | CAT 121 | 15 | 3297 |

All of the compounds, complexes, and methods disclosed and claimed herein can be made and executed without undue experimentation in light of the present disclosure. While the compounds, complexes, and methods of this disclosure have been described in terms of certain embodiments, it will be apparent to those of skill in the art that variations may be applied to the compounds, complexes, and methods, as well as in the steps or in the sequence of steps of the method described herein without departing from the concept, spirit, and scope of the appended claims. More specifically, it will be apparent that certain compounds which are chemically related may be substituted for the compounds described herein while the same or similar results would be achieved. Similar substitutes and modifications apparent to those skilled in the art are deemed to be within the spirit, scope and concept of the present disclosure as defined by the appended claims.

### REFERENCES

The following references to the extent that they provide exemplary procedural or other details supplementary to those set forth herein, are specifically incorporated herein by reference.
U.S. Pat. No. 2,825,721
U.S. Pat. No. 3,780,011
U.S. Pat. No. 3,819,811
U.S. Pat. No. 3,976,632
U.S. Pat. No. 4,041,224
U.S. Pat. No. 4,053,565
U.S. Pat. No. 4,173,548
U.S. Pat. No. 4,177,162
U.S. Pat. No. 4,297,460
U.S. Pat. No. 4,374,234
U.S. Pat. No. 4,981,927
U.S. Pat. No. 5,037,911
U.S. Pat. No. 5,198,400
U.S. Pat. No. 5,534,472
U.S. Pat. No. 6,147,171
U.S. Pat. No. 6,569,960
U.S. Pat. App. Pub. No. 2013/0090437

Anderson, N. G., Practical Process Research & Development A Guide for Organic Chemists, 2^{nd} ed., Academic Press, New York, 2012.
Arnett and Thomas, “Zero-shear viscosity of some ethyl branched paraffinic model polymers,” J. Phys. Chem., 84(6):649-652, 1980.
Monrabal and Sancho-Tello, “High Temperature GPC Analysis of Polyolefins with Infrared Detection,” Polymer Char: The Application Notebook, LCGC Asia Pacific, 2009.
Shroff and Mavridis, “New Measures of Polydispersity from Rheological Data on Polymer Melts,” J. Appl. Poly. Sci., 57(13):1605-1626, 1995.
Shroff and Mavridis, “Long-Chain-Branching Index for Essentially Linear Polyethylenes,” Macromolecules, 32(25):8454-8464, 1999.

Yau and Gillespie, “New approaches using MW-sensitive detectors in GPC-TREF for polyolefin characterization,” Polymer, 42(21): 8947-8958, 2001.
Yau, et al., “Chemical Composition Analysis of Polyolefins by Multiple Detection GPC-IR5,” Polymer Char: The Application Notebook, LCGC North America, 2011.

What is claimed is:

1. A composition comprising:
(A) a first catalyst comprising from 0.25-2 wt. % chromium deposited on a first solid oxide component, wherein the first catalyst has a pore volume from 1.0-3.5 mL/g and a surface area from 250-900 m²/g; and
(B) a second catalyst comprising from about 0.25-2 wt. % chromium deposited on a second solid oxide component, wherein the second catalyst has a pore volume from 1.0-2.5 mL solid/g and a surface area from 400-1000 m²/g;
wherein the first and second catalysts are present a weight ratio from 1:9-9:1, provided that the first catalyst and second catalyst are not the same.

2. The composition of claim 1, wherein the first catalyst further comprises from 0.5-5.0 wt. % titanium or aluminum.

3. The composition of claim 1, wherein the first catalyst has a surface area from 250-600 m²/g.

4. The composition of claim 1, wherein the second catalyst further comprises from 0.5-5 wt. % aluminum, titanium, or zirconium or from 0.1-1 wt. % boron or fluorine.

5. The composition of claim 1, wherein the second catalyst has a surface area from 500-1000 m²/g.

6. The composition of claim 1, wherein the first catalyst has a pore volume from 1.0-2.5 mL/g.

7. The composition of claim 1, wherein the first solid oxide component and the second solid oxide component consist essentially of silica.

8. A method comprising:
(A) obtaining a first catalyst, wherein:
the first catalyst comprising from 0.25-2 wt. % chromium deposited on a first solid oxide component, wherein the first catalyst has a pore volume from 1.0-3.5 mL/g and a surface area from 250-900 m²/g;
(B) heating the first catalyst to a temperature from 700-900° C. to form an activated first catalyst;
(C) obtaining a second catalyst, wherein:
the second catalyst comprising from 0.25-2 wt. % chromium deposited on a second solid oxide component, wherein the second catalyst has a pore volume from 1.0-2.5 mL/g and a surface area from 400-1000 m²/g; and
either one of steps (D) and (E):
(D) heating the second catalyst to a temperature from 400-700° C. to form an activated second catalyst and then admixing the activated second catalyst to the first activated first catalyst; or
(E) admixing the second catalyst to the activated first catalyst and heating this catalyst mixture to a temperature from 400-700° C. to further activate this catalyst mixture;
wherein the first and second activated catalysts are present in a weight ratio from 1:9-9:1, provided that the first activated catalyst and second activated catalyst are not the same.

9. The method of claim 8, wherein the first catalyst and second catalyst are heated in the presence of air.

10. A method comprising:
(A) admixing a monomer, wherein the monomer is an olefin_{(C≦6)}, and the composition of claim 1 to form a reaction mixture; and
(B) reacting the monomer in the presence of the composition under conditions sufficient to form a polyolefin with a bimodal molecular weight distribution.

11. The method of claim 10, wherein the monomer is ethylene and the polyolefin is polyethylene.

12. The method of claim 10, wherein the first mode of the molecular weight distribution of the polyolefin is a low molecular weight mode from 80,000-130,000 Daltons and wherein the second mode of the molecular weight distribution of the polyolefin is a high molecular weight mode from about 84,000-300,000 Daltons, provided that the average molecular weight of the second mode is greater than the first mode.

13. The method of claim 10, wherein the amount of the monomer is from 0.1-15 mol. % of the total soluble components.

14. The method of claim 10, wherein the method further comprises adding a comonomer to the reaction mixture, wherein the comonomer is an olefin_{(C≦12)}.

15. The method of claim 14, wherein the comonomer is hexene.

16. The method of claim 10, wherein the high molecular weight mode of the polyolefin has a lower extent of long chain branching relative to the low molecular weight mode of the polyolefin, as measured by the long chain branching index.

17. The method of claim 14, wherein the high molecular weight mode of the polyolefin contains more of the incorporated comonomer relative to the low molecular weight mode of the polyolefin, as measured by short chain branching index.

18. The method of claim 17, wherein the high molecular weight mode of the polyolefin has a lower extent of long chain branching relative to the low molecular weight mode of the polyolefin, as measured by the long chain branching index.

19. The method of claim 10, wherein the method further comprises adding:
(a) a co-catalyst selected from the group consisting of trialkylboron_{(C≦24}), trialkylaluminum_{(C≦24)}, dialkylzinc_{(C≦18)}, and alkyllithium_{(C≦12)};
(b) hydrogen gas; or
(c) both (a) and (b);
to the reaction mixture; and heating the reaction mixture to a temperature from about 75-120° C.

20. The method of claim 19, wherein the trialkylboron_{(C≦12)} is triethylboron.
